(19) United States
(12) Patent Application Publication
(10) Pub. No.: US 2005/0216247 A1
(43) Pub. Date: Sep. 29, 2005

(54) Method and program for verifying logic circuit having asynchronous interface

(75) Inventors: Noriyuki Ikeda, Kawasaki (JP); Masami Iwamoto, Kawasaki (JP); Hiroe Iwamura, Kawasaki (JP); Kentaro Ikeuchi, Kawasaki (JP); Youichi Tsuruta, Kawasaki (JP); Junji Sonoda, Kawasaki (JP); Atsushi Watanabe, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/935,109

(22) Filed: Sep. 8, 2004

(30) Foreign Application Priority Data
Mar. 29, 2004 (JP) 2004-094030

(51) Int. Cl. G06F 17/50

(52) U.S. Cl. 703/19

(57) ABSTRACT

A method of verifying functionality of a logic circuit containing asynchronous interfaces with sufficient accuracy and efficiency. When an RTL code is given, the asynchronous point extraction program extracts therefrom all asynchronous points and creates an asynchronous point list that enumerates them. A control task inserter modifies the RTL code with additional control tasks, as well as producing a control card for a clock & delay controller. The modified RTL code is then directed to a logic simulator. Control tasks inserted in the RTL code permit the simulator to cooperate with the clock & delay controller, so that modulated clocks and delayed signals will act on the RTL model during a logic simulation. A wide range of possible delay situations are produced in the logic simulation phase prior to logic synthesis, which enables accurate and efficient verification of a logic circuit containing asynchronous interfaces.

### CROSS-REFERENCE TO RELATED APPLICATIONS

This application is based upon and claims priority of Japanese Patent Application No. 2004-094030, filed on Mar. 29, 2004, the contents being incorporated herein by reference.

### BACKGROUND OF THE INVENTION

1. Field of the Invention

The present invention relates to a method and program for verifying a logic circuit having asynchronous interfaces. More particularly, the present invention relates to a method and program for verifying, through simulation, the functions of a logic circuit having an asynchronous point at which signals travel from one clock domain to another.

2. Description of the Related Art

Hardware description languages (HDLs) are used to develop large scale integrated (LSI) circuits for system-on-chip solutions and other applications. HDL-based design tools enable hardware designers to describe the behavior of a digital circuit with a high-level language. A typical design process involves conversion from a behavioral description to a code that defines logic functions of a circuit at the register transfer level (RTL). This RTL code is then subjected to a logic simulator set up with a test bench to verify the operation of the logic circuit.

FIG. 30 shows an example of a conventional process flow of digital circuit design. The illustrated process begins with describing logic circuit functions in the form of an RTL code (step S100) and then proceeds to logic simulation with that RTL code (step S101). After the design is validated at RTL level, it is converted into a gate-level implementation with a logic synthesis tool (step S102). This is followed by preliminary wiring, loading of gate libraries, and creation of a standard delay file (SDF) containing specific delay values of individual wires. The completion of those preparatory tasks permits the designer to execute a gate-level logic simulation (step S103) using preliminary wire delays. After a subsequent circuit layout process (step S104) and timing check with a static timing analyzer (STA) (step S105), sample chips are fabricated (step S106) for prototype evaluation tests (step S107).

If the gate-level simulation at step S103 ends up with an unsatisfactory result, the designer should go back to step S100 to modify the logic design data. He/she then re-creates an RTL code with the modified data and follows all subsequent steps again. This kind of design iteration may also happen in the case an error is found in the static timing analysis at step S105 or in the prototype evaluation at step S107. Depending on what problems are revealed by the prototype evaluation at step S107, the designer has to return to step S102 for logic synthesis, step S103 for gate-level logic simulation, step S104 for layout, or step S105 for static timing analysis. In addition to the above, the RTL code produced at step S100 is subjected to a formal verification tool at an appropriate time (step S108), and if the result is unsatisfactory, the designer goes back to step S100 to create an RTL code again.

Many logic circuits have some portions that need to handle asynchronous signals. Specifically, hardware designers have to be aware of asynchrony when designing, for example, an interface circuit that receives an asynchronous incoming signal from an external source. In this case, a synchronizer is placed at the front end to make the input signal synchronous with the receiver's local clock. Asynchrony also exists in multi-clock designs, where two or more internal circuit blocks operate on different clock signals. When a signal crosses from one such block to another, the signal appears to be asynchronous in the new clock domain.

Design methodologies for dealing with such asynchrony in a circuit have become more and more important in recent years as the market pursues greater functionality and higher performance for digital logic solutions. In this description, we uses the term “asynchronous interface” to refer to a digital logic circuit containing one or more asynchronous points where signals travel from one clock domain to another, as in the examples mentioned above.

FIG. 31 shows a simplest model of an asynchronous interface. A signal sent out of a flip-flop circuit 201 (“sending register”) operating with a clock signal CLKM is received by two cascaded flip-flop circuits 202a and 202b (“receiving registers”) operating with another clock signal CLKN. Those registers 201, 202b, and 202b may be single-bit flip-flops or multiple-bit registers, depending on the bit width of the signal that they transfer. The receiving registers 202a and 202b constitute a so-called double synchronizer, which is a classical method used to receive an asynchronous signal correctly. Such an asynchronous interface 200, however, is likely to experience non-simultaneous propagation, early propagation, and late propagation, as shown in FIGS. 32, 33, and 34, respectively. These phenomena are peculiar to asynchronous interfaces.

Non-simultaneous propagation is a phenomenon that happens to multiple-bit data path signals. When it happens, the signals would stay in an indefinite state for a certain period of time. FIG. 32 shows a situation where an indefinite output state of the sending register 201 propagates to the receiving registers 202a and 202b, possibly causing a problem in succeeding processing stages.

Early propagation is a phenomenon that a signal is received one cycle earlier than intended. FIG. 33 shows an example of early propagation, where the receiving registers 202a and 202b receive the output signal of the sending register 201 one cycle period of CLKN earlier than the intended timing.

Late propagation is a phenomenon that a signal is received one cycle later than intended. FIG. 34 shows a situation where an increased delay at the sending register 201 causes an unintended delay of one CLKN cycle period at the receiving registers 202a and 202b.

The occurrence of non-simultaneous propagation, early propagation, or late propagation does not mean the presence of a design failure per se. In fact, their occurrence is unavoidable, but it is possible to prevent it from leading to a real problem if the surrounding circuits are carefully designed not to be sensitive to such situations. Non-simultaneous propagation, for example, would not do harm to a receiving circuit if that circuit is designed to neglect the first clock cycle of each incoming signal that it receives from an asynchronous peer circuit, since non-simultaneous propagation does not last beyond one clock cycle.

FIGS. 35 and 36 show other examples of asynchronous interfaces. Referring first to FIG. 35, the illustrated asynchronous interface 300 has a combinatorial logic circuit 302 connected to the outputs of two separate registers 301a and 301b both operating with a clock signal CLKM in the sending end. The output of this combinatorial logic circuit 302 is delivered to a single-stage receiving register 303 that operates with a different clock signal CLKN. Such an asynchronous interface 300, however, tends to experience a timing hazard or an unexpected signal delay. Particularly, since it is of a single-synchronizer structure, the receiving register 303 would produce an indefinite output when a change in the input signal is close to the clock edge. This circuit 300 is highly likely to fall into a problem situation discussed above.

Shown in FIG. 36 is another asynchronous interface 400, which is composed of first and second asynchronous interfaces 410 and 420. The first asynchronous interface 410 has a sending register 411 operating with a clock signal CLKM, whose output is received by two receiving registers 412a and 412b operating with another clock signal CLKN, as in the foregoing asynchronous interface 200 of FIG. 31. Similarly, the second asynchronous interface 420 has a sending register 421 operating with CLKM, whose output is received by two receiving registers 422a and 422b operating with CLKN. The two asynchronous interfaces 410 and 420 feed their respective output signals to a single combinatorial logic circuit 430.

While non-simultaneous propagation or other situations could occur to both asynchronous interfaces 410 and 420, it does not matter to them. However, a problem could manifest itself at the subsequent combinatorial logic circuit 430.

FIG. 37 shows an example of a problem situation that may happen to the asynchronous interface 400 of FIG. 36. This example assumes that one output signal (III) from the upper receiving register 412b is used as a control signal, while the other output signal (IV) from the lower receiving register 422b is supposed to mask that control signal. Referring to the upper half of FIG. 37, the mask signal (IV) normally goes to low before the control signal (III) becomes active, and thus the control signal will be masked successfully at the combinatorial logic circuit 430.

In the case shown in the lower half of FIG. 37, on the other hand, the input signal (I) is in an early propagation condition at the upper receiving register 412a, while the other input signal (II) is in a late propagation condition at the lower receiving register 422a. This situation reverses the timing relationship between the control signal (III) and mask signal (IV), thus resulting in an unmasked active control signal appearing at the combinatorial logic circuit 430. Although the combinatorial logic circuit 430 may be designed to neglect the change in its input signals for one clock cycle period, it would not solve the situation if such timing margin is used up for the illustrated combination of early propagation and late propagation.

For another example, consider a variation of the asynchronous interface 400 of FIG. 36. Specifically, the output signal (IV) is multiple-bit data, and the signal (I) is an enable signal that qualifies the data signal with sufficient timing margin. At the receiving end, however, the enable signal (III) is subject to early propagation or non-simultaneous propagation problems, and the output data signal (IV) could be affected by non-simultaneous propagation of the multiple-bit data signal (II). A functional error could occur if the combinatorial logic circuit 430 receive distorted signals in this way.

As can be seen from the above, asynchronous interfaces are prone to encounter timing problems. Conventional design tools permit the designer to verify the functionality of a circuit at appropriate design stages such as RTL logic simulation, gate-level logic simulation, and static timing analysis. While capable of verifying circuits from their structural viewpoint using double latches and the like, RTL logic simulation tools are unable to handle non-simultaneous propagation caused by timing differences between multiple signals because RTL lacks consideration of temporal elements. For example, conventional logic simulation assumes no difference in signal delays when handling 32-bit data, DATA[31:0]. This means that conventional RTL simulations neglect non-simultaneous propagation that possibly happens when DATA[31:0] changes.

Gate-level logic simulation tools, on the other hand, take into account the signal-to-signal timing differences. For example, data path signals DATA[31:0] are divided into individual bits DATA[31], DATA[30], . . . DATA[0], so that different delay values can be assigned to them through SDF backannotation. In most cases, however, the typical amount of variation is extremely small, meaning that the indefinite state disappears in a very short time. The designer is unable to discover timing problems lurking in a circuit unless such a short indefinite period leads to an error. Note that the above discussion applies not only to a single set of data path signals, but also to a combination of data path signals and their control signal, and any other group of two or more associated signals.

Regarding functional verification of asynchronous interfaces, several researchers propose specific methods to identify asynchronous points in an RTL code (see, for example, Japanese Patent Application Publication No. 2003-108619). Another proposed technique is to verify the circuit behavior in more stringent conditions by producing metastability at a circuit next to an asynchronous point that is found in an RTL code (see, for example, Japanese Patent Application Publications Nos. 2003-233638 and 2001-229211).

### SUMMARY OF THE INVENTION

The present invention provides a method of verifying behavior of a logic circuit having an asynchronous interface. This method comprises the steps of: (a) extracting an asynchronous point from a logic circuit defined at a register transfer level; and (b) verifying functionality of the logic circuit through simulation, taking into account a delay that could occur at the extracted asynchronous point.

Also, the present invention provides a program product stored in a computer-readable storage medium for verifying behavior of a logic circuit having an asynchronous interface. This program product causes a computer system to function as an apparatus comprising: (a) an asynchronous point extractor that extracts an asynchronous point in a logic circuit defined at a register transfer level; and (b) a verifier that verifies functionality of the logic circuit through simulation, taking into account a delay that could occur at the asynchronous point extracted by the asynchronous point extractor.

Further, the present invention provides a program product stored in a computer-readable storage medium for verifying behavior of a logic circuit having an asynchronous interface. This program product causes a computer system to function as an apparatus comprising: (a) a control task inserter that inserts a control task to an asynchronous point in a logic circuit defined at a register transfer level; and (b) a delay controller that uses the control task to produce a delay in the logic circuit during a simulation thereof.

The above and other features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 gives an overview of an asynchronous interface verification system according to the present invention.

FIG. 2 is a conceptual view of an asynchronous interface verification environment.

FIG. 3 shows an example of an asynchronous interface verification system according to the present invention.

FIG. 4 shows a process flow of a clock & delay controller.

FIG. 5 shows a typical circuit design flow using the asynchronous interface verification system of the present invention.

FIGS. 6A and 6B show a benefit of using the proposed functional verification techniques in asynchronous circuit design.

FIGS. 7A and 7B show a clock modulation task.

FIG. 8 explains phase skews.

FIG. 9 explains duty ratios.

FIG. 10 explains jitters.

FIG. 11 explains clock modulation.

FIGS. 12A and 12B show an example of how a signal is changed by clock modulation.

FIGS. 13A and 13B show a signal delay.

FIG. 14 shows forcible delay control.

FIG. 15A and 15B show how a delay is given to each bit of a multiple-bit data signal.

FIGS. 16A and 16B show delay parameter control for delaying signals at the sending end.

FIG. 17 shows delay parameter control for delaying signals at the receiving end.

FIGS. 18A and 18B show an example of how a signal is changed by delay insertion.

FIG. 19 is an example of hardware configuration of a computer platform.

FIG. 20 shows signal propagation in a TBridge_top circuit.

FIG. 21 is a block diagram of the TBridge_top circuit.

FIG. 22 is an asynchronous point list of the TBridge_top circuit.

FIGS. 23 and 24 show a control card.

FIG. 25 is a timing diagram showing the originally intended behavior of the TBridge_top circuit.

FIG. 26 shows a part of verification results of a conventional RTL logic simulation.

FIG. 27 shows a part of verification results of RTL logic simulation using the asynchronous interface verification system of the present invention.

FIG. 28 is a timing diagram showing an expected problem situation.

FIG. 29 is a timing diagram showing the operation of a TBridge_top circuit that is modified to avoid the problem situation shown in FIG. 28.

FIG. 30 shows an example of a conventional circuit design flow.

FIG. 31 shows a simplest model of an asynchronous interface.

FIG. 32 explains non-simultaneous propagation.

FIG. 33 explains early propagation.

FIG. 34 explains late propagation.

FIG. 35 shows a typical asynchronous interface.

FIG. 36 shows another typical asynchronous interface.

FIG. 37 shows an example of an error occurred to the asynchronous interface of FIG. 36.

FIG. 38 shows an asynchronous interface verification method proposed by other researchers.

### DESCRIPTION OF THE PREFERRED EMBODIMENTS

As stated in the Description of the Related Art, when there are data path signals crossing asynchronously from a sending circuit to a receiving circuit, logic designers usually considers, as their normal design practice, the possible occurrence of a non-simultaneous signal change at the sending circuit, as well as the expected consequences of an indefinite state sampled at the receiving circuit. As mentioned earlier, RTL logic simulators are unable to simulate non-simultaneous propagation caused by signals with different delays. This is clearly a limitation of the existing RTL functional verification tools.

While gate-level simulators are capable of giving different delays to multiple signals to simulate non-simultaneous propagation, the indefinite state produced in a gate-level simulation is so short that the receiving circuit can only sample it by pure coincidence. For this reason, designers often overlook potential problems related to asynchrony in their circuit. Furthermore, since gate-level simulation is relatively slow, it is simply unpractical to apply a sufficiently long sequence of test vectors in each simulation session, particularly when the product development time is limited. Thus the designers often resort to final real-device testing with randomly selected sample chips to ensure the absence of error in the circuit under test.

Static timing analysis is another step in the circuit design flow. Before performing this analysis, the designer has to convert a high-level description of design into an optimized gate-level representation by using a logic synthesis tool. While the analyzer may indicate some errors in the synthesized netlist, it is difficult for the designer to locate or duplicate a problem in the original RTL code from the netlist.

Actually, static timing analysis takes a large amount of time and labor, which may be attributed to: need for gate libraries and SDF files, slow simulation speeds ( 1/100 or less of RTL simulations), inability to control logic delays in an RTL code, no support for multiple-stage gated clock design, and need for layout optimization considering gate delays and wire delays.

A layout change at this stage of development would affect the result of static timing analysis or logic simulation. This means a risk of introducing some problem in the asynchronous design, which the designer may overlook. It is necessary, however, to modify the layout if a problem is found at the stage of static timing analysis.

In calculating delays and timings, a static timing analyzer often detects setup and hold time violations. What the analyzer is suggesting here is not logic errors, but timing errors, although a logic error could be concealed behind a timing error. The primary purpose of static timing analysis to check the timing performance of a design. It is not for finding a problem lurking in the RTL logic design. The functionality of an asynchronous interface cannot be checked by a static timing analyzer alone.

Testing an asynchronous interface with the above-described methods could actually reveal a number of asynchronous points. If this is the case, the presence of many asynchronous points could bring a problem into some other circuit whose functionality has already been proved.

Prototype evaluation is the final test for the design. One simple approach to increase the chance of discovering latent problems in an asynchronous interface is to repeat the test as many times as possible. While a design error can actually be found in the prototype evaluation, it is very hard to locate the cause of the problem since such analysis requires a tremendous amount of time and labor at this late stage. Even if the designer could locate a problem and come up with a solution, there is nothing that warrants us that every bug in the design has been fixed, and in addition, a new version of sample chips have to be fabricated for final evaluation.

Regarding the formal verification, existing tools can check, in the formal aspects, whether the circuit operates properly at an asynchronous point. However, this feature of formal verifiers is not powerful enough to ensure the proper functionality of such a circuit that samples two or more bits individually with different clocks.

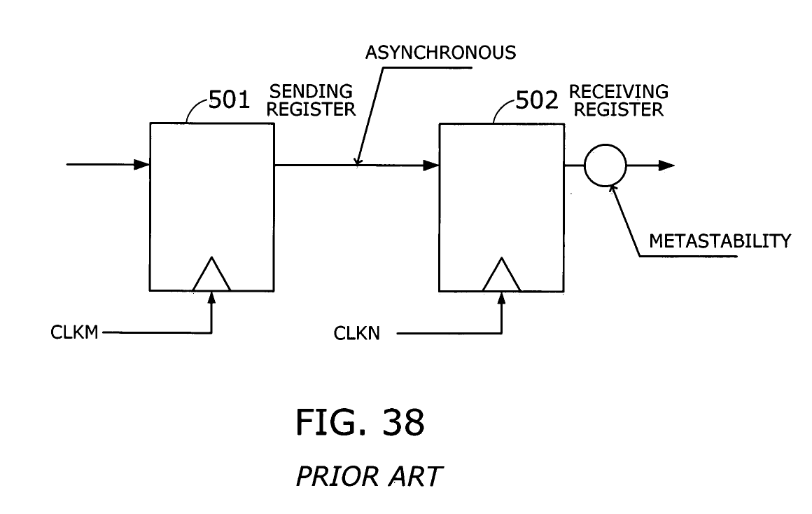

In view of the above, some researchers have proposed an asynchronous interface verification method shown in FIG. 38. The illustrated circuit has a sending register 501 in a clock domain CLKM and a receiving register 502 in another clock domain CLKN. The verification method forcibly gives metastability, or indefinite state, to the output of the latter register 502 to test whether the propagation of that state will not produce problems.

The proposed verification method, however, may not be effective enough to find interference between one asynchronous point and another when the circuit under test has many such asynchronous points. Another imperfection of this method is the lack of capability of generating early propagation or late propagation of signals intentionally. As yet another imperfection, the forced indefinite state may disappear at the receiving circuit when it has two cascaded stages of flip-flops or registers. This is because the indefinite state lasts one cycle period at most and a short indefinite state less than one cycle at the output of the first flip-flop would not propagate to the second flip-flop.

As can be seen from the above, the existing verification methods, including static timing analysis, do not provide sufficient performance for verifying the functions of an asynchronous interface, despite the fact that such circuits are increasingly complex and important. The lack of appropriate tools imposes a considerable workload on the circuit designers since they have to repeat a multiple-step process many times, devoting large amounts of time and labor. This also results in longer development and production times of LSI circuits.

In view of the foregoing, it is an object of the present invention to provide a method and program capable of verifying correct signal transfer at asynchronous points in a logic circuit, with sufficient accuracy and efficiency in the RTL simulation phase of a design process.

Preferred embodiments of the present invention will now be described in detail below with reference to the accompanying drawings, wherein like reference numerals refer to like elements throughout.

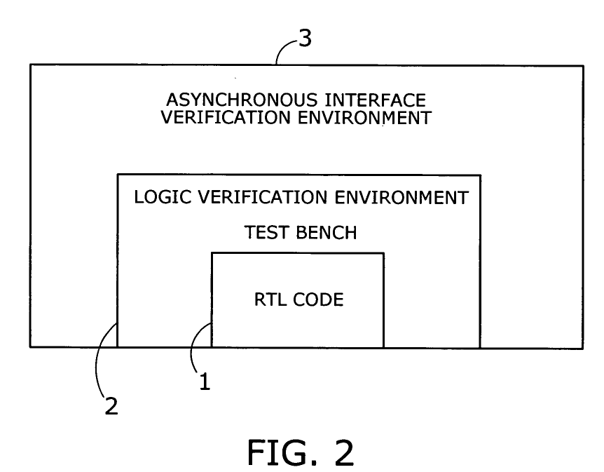

FIG. 2 is a conceptual view of an asynchronous interface verification environment. Conventionally, circuit designers create an RTL code 1 representing their logic design and write a test bench for use in logic simulation to ensure that it functions as intended. Provided for this purpose is a logic verification environment 2. According to the present invention, to implement new test functions for asynchronous aspects of a logic circuit, an asynchronous interface verification environment 3 is provided as an outer-layer structure that contains a conventional logic verification environment 2. This means that asynchronous operation of a logic circuit can be verified by using an existing logic verification environment 2, without the need for preparing a new test bench for that purpose. It is easy to implement such an asynchronous interface verification environment 3 in combination with an existing circuit design system. When a problem related to asynchrony is found in the functional verification process, the designer can isolate and reproduce it easily by using the RTL code 1 and logic verification environment 2.

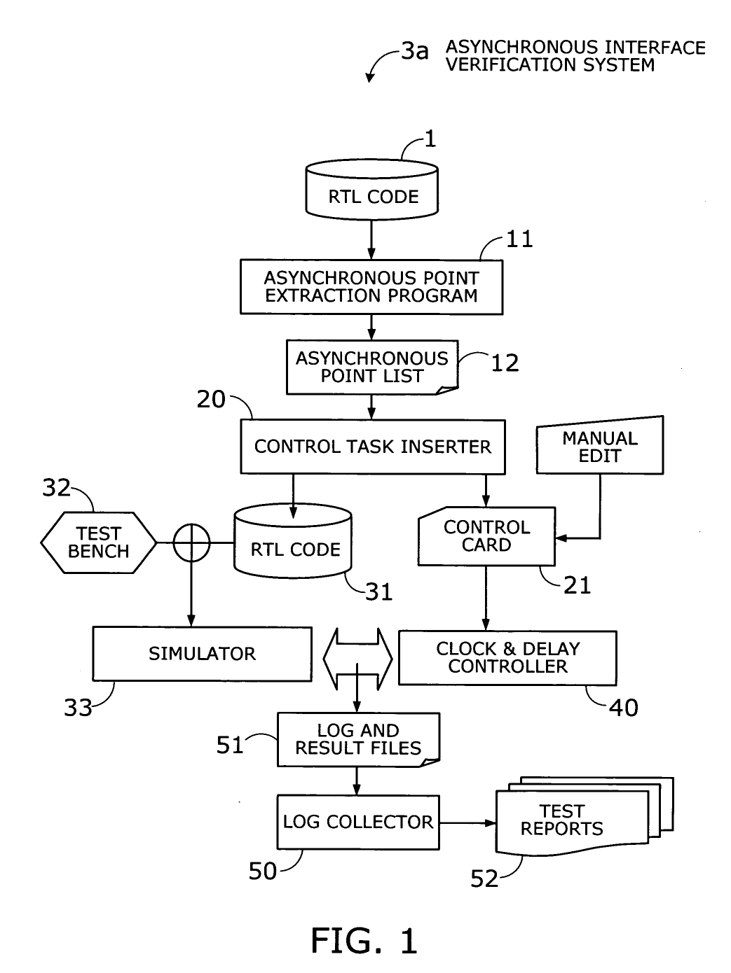

FIG. 1 gives an overview of an asynchronous interface verification system according to the present invention. With the illustrated asynchronous interface verification system 3a, the circuit designer creates an RTL code 1 representing a logic design, using the same method as in the conventional systems. This RTL code 1 is then subjected to an asynchronous point extraction program 11 to automatically extract asynchronous points included in the logic circuit. The term “asynchronous point” refers here to an interface point at which a signal is passed from one clock domain to another clock domain.

With the RTL code 1 given, the asynchronous point extraction program 11 extracts therefrom every asynchronous point to create an asynchronous point list 12 that enumerates all those asynchronous points and other associated information. For each entry of asynchronous point, the asynchronous point list 12 indicates between which clock groups a signal is resynchronized, and at which point the signal delay should be manipulated in a logic simulation session. The latter is referred to as a delay insertion point descriptor, which includes the following pieces of information: sending clock, sending register, receiving clock, and receiving register.

According to the above asynchronous point list 12 passed from the asynchronous point extraction program 11, the control task inserter 20 modifies the given RTL code 1 and simulation test bench by inserting additional control tasks. Those control tasks implement clock modulation and delay insertion at each asynchronous point at the time of simulation. Also produced is a control card 21 containing several control parameters for a simulator 33 to work together with a clock & delay controller 40 in performing a logic simulation. The parameters include: clock groups, clock modulation levels, delay insertion point information, and signal delay values. The control task inserter 20 determines those control parameters automatically from clock group information and delay insertion point descriptors in the asynchronous point list 12. The circuit designer is allowed to modify the parameters afterwards if it is necessary.

As mentioned, the control task inserter 20 inserts additional control tasks into the RTL code 1 and test bench. The control tasks are broadly divided into two groups: clock modulation tasks to modulate clock signals in a given circuit and delay control tasks to provide the circuit with a specific signal delay. Each control task has an interface function that helps the clock & delay controller 40 and simulator 33 work together in an organized manner. The control task inserter 20 inserts a clock modulation task to each specified clock group in the original RTL code 1 and a delay control task to each specified delay insertion point, thereby producing a modified RTL code 31 and test bench 32, respectively.

The resultant RTL code 31 and test bench 32 are then directed to a logic simulation process using the simulator 33. Clock modulation tasks and delay control tasks in the RTL code 31 permit the simulator 33 to interface with the clock & delay controller 40, so that modulated clocks and delayed signals will be produced in the course of logic simulation of the RTL code 31. The simulator 33 detects and records errors and other events occurred in this process, thus producing log and result files 51. Those files 51 are supplied to a log collector 50 to analyze the simulation results in association with error-related records. The analyzed test coverage information is displayed on a monitor screen of the asynchronous interface verification system 3a in the form of test reports 52, which can also be printed out if necessary.

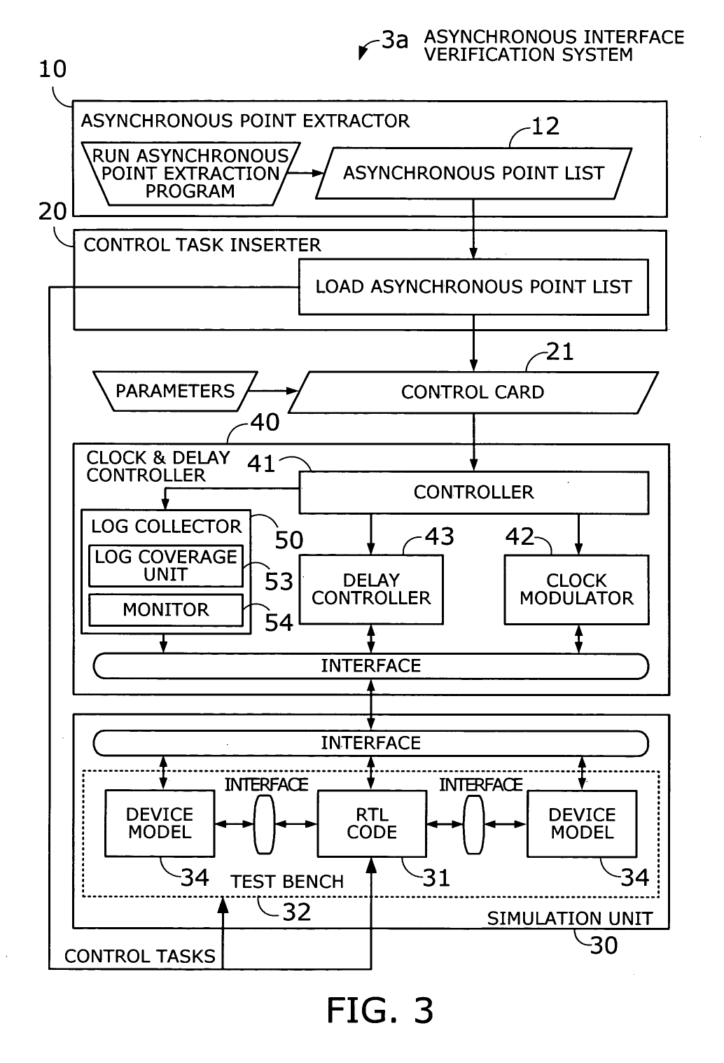

FIG. 3 shows a more specific example of the asynchronous interface verification system 3a according to the present invention. This system 3a is composed roughly of an asynchronous point extractor 10, a clock & delay controller 40, and a simulation unit 30. The asynchronous point extractor 10 produces a control card 21 from a given RTL code 1, and based on that control card 21, the clock & delay controller 40 controls clock modulation and signal delays in logic simulation. Device models 34 are used in the simulation unit 30, together with an RTL code 31 and test bench 32 containing additional clock modulation tasks and delay control tasks. The RTL code 31 is coupled to each device model 34 through an interface. The simulation unit 30 executes a logic simulation of the RTL code 31 with its simulator module 33 (not shown in FIG. 3) while allowing the clock & delay controller 40 to modulate clocks and effect signal delays.

The asynchronous point extractor 10 runs an asynchronous point extraction program 11 to look into the original RTL code 1 and compile an asynchronous point list 12. With the resulting asynchronous point list 12, the control task inserter 20 creates a control card 21 containing control parameters for use by the clock & delay controller 40. If necessary, the designer specifies or modifies control parameters in the control card 21. The control task inserter 20 also inserts control tasks into the original RTL code 1 and test bench (not shown), thereby producing an RTL code 31 and test bench 32 for simulation purposes.

The clock & delay controller 40 has a clock modulator 42 and a delay controller 43, and a controller 41 to manage them. The clock modulator 42 and delay controller 43 invoke unit programs corresponding to clock modulations and signal delays in a logic simulation session. To perform its task, the controller 41 consults control parameters in the control card 21.

More specifically, according to given control parameters, the clock modulator 42 invokes a clock modulation unit for each clock modulation task inserted in the RTL code 31 and test bench 32. The delay controller 43, on the other hand, invokes a delay control unit for each delay control task, with reference to the control parameters. Actually, as many clock modulation units as the number of clock groups are prepared, as are as many delay control units as the number of delay insertion points.

The invocation of a clock modulation unit at the clock modulator 42 enables the clock & delay controller 40 and simulation unit 30 to work jointly through the corresponding clock modulation task in the RTL code 31. This makes the simulation unit 30 ready to modulate a clock signal. When a logic simulation of the RTL code 31 is started, the clock modulation units associated with different clock groups begin to modulate their respective clock signals independently.

Likewise, the invocation of a delay control unit at the delay controller 43 enables the clock & delay controller 40 and simulation unit 30 to work jointly through the corresponding delay control task in the RTL code 31. This makes the simulation unit 30 ready to give a signal delay. When a logic simulation of the RTL code 31 is started, the delay control units associated with different delay insertion points begin to delay their respective signals independently.

The log collector 50 has a log coverage unit 53 and a monitor 54 to track and record the process of logic simulation. Briefly, the log coverage unit 53 records, among others, errors observed during the logic simulation, clock modulation given to each clock signal, and delay time given to each, signal. The monitor 54 traces signal waveforms, including signals affected by clock modulation and/or signal delay. Full details of those functions will be provided later in a separate section.

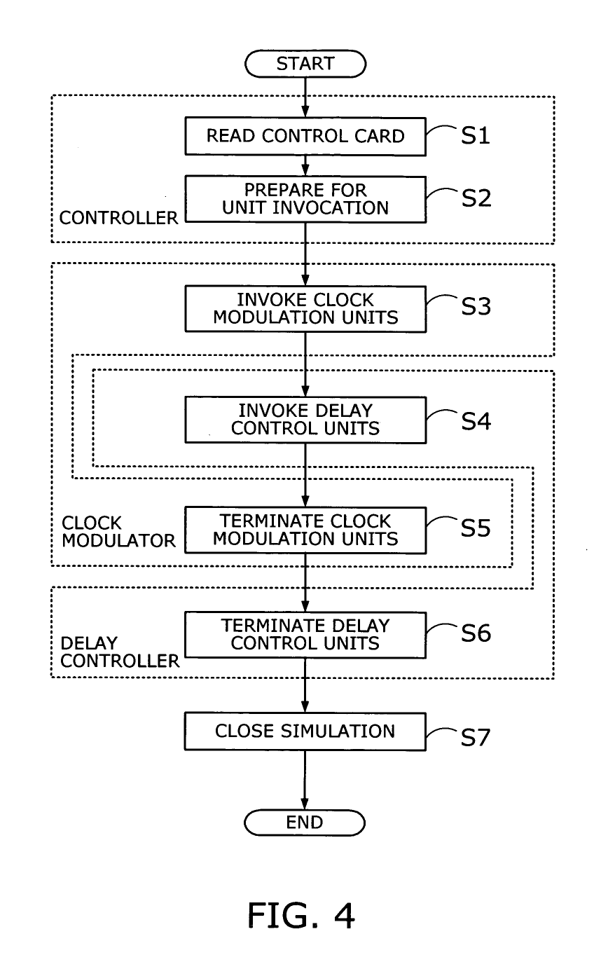

FIG. 4 shows a process that the clock & delay controller 40 executes when the simulator 33 in the simulation unit 30 performs a logic simulation with a given RTL code 31 and test bench 32 including additional control tasks. This process goes as follows:

To have the clock modulator 42 and delay controller 43 invoke clock modulation units and delay control units, the clock & delay controller 40 first causes the controller 41 to read the information about simulation conditions from a given control card 21 (step S1). Based on that information, the clock & delay controller 40 then makes settings for unit invocation (step S2), thus allowing the clock modulator 42 to invoke as many clock modulation units as the number of clock groups (step S3). Clock modulation takes place at each clock modulation task that has been inserted in the RTL code 31 under simulation. The delay controller 43, on the other hand, invokes as many delay control units as the number of delay insertion points (step S4), thus giving a signal delay at each delay control task that has been inserted in the RTL code 31 under simulation.

When the logic simulation process is finished, the clock & delay controller 40 commands the clock modulator 42 and delay controller 43 to terminate clock modulation units and delay control units (steps S5 and S6), respectively. Finally, the clock & delay controller 40 closes its interface with the simulator 33.

### Circuit Design Flow

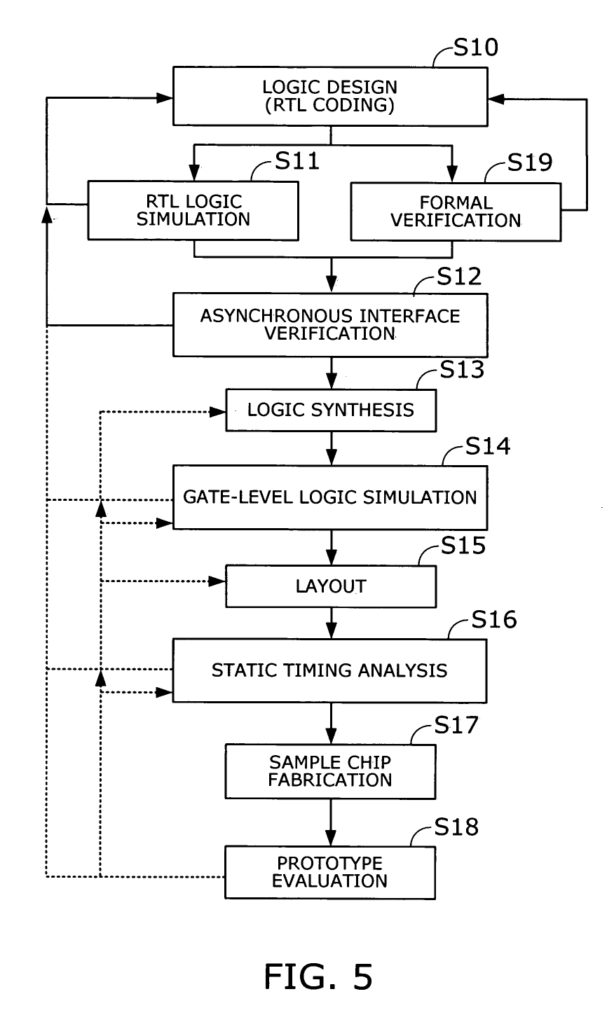

FIG. 5 shows a typical circuit design flow using the asynchronous interface verification system 3a of the present invention. The illustrated design flow begins with an initial logic design; that is, a logic circuit is created as an RTL code 1 having some asynchronous points (step S1). The RTL code 1 is then subjected to a logic simulation (step S11), where the functions of the RTL code 1 are verified (step S12). As described earlier, this simulation stage involves the task of extracting asynchronous points from the original RTL code 1. Based on a control card 21 that is created, the clock & delay controller 40 gives intentional clock modulation and signal delay to the RTL code 31, which contains additional control tasks for that purpose.

If a problem with the RTL code 31 is found during the functional verification process, the designer goes back to step S10 to correct his/her design data and retries the same logic simulation with the updated RTL code 31. This debug cycle is repeated until no error is indicated in the simulation. Then the process advances to logic synthesis (step S13) using an existing design tool, which is followed by preliminary wiring, reading of gate libraries, creation of SDF, and gate-level logic simulation (step S14). After the subsequent circuit layout (step S15) and static timing analysis (step S16), sample chips are manufactured (step S17) for prototype evaluation (step S18).

In addition to the above-described steps, a formal verification is performed (step S19) at an adequate time after the logic design step S10 is finished. If this formal verification is not successful, then the designer should return to step S10 to make necessary modifications to the logic design data.

The above-described circuit design process includes clock modulation and signal delay generation in the phase of RTL logic simulation. The aim of this is to produce various situations that the circuit at asynchronous points will actually encounter when it is implemented. Specifically, the simulator forces the circuit to experience frequent non-simultaneous propagation, early propagation, late propagation, and other situations peculiar to asynchronous interfaces. Besides testing the circuit behavior at the exact asynchronous points that have been extracted, the proposed verification system examines the subsequent signal propagation on other circuits, as well as the possible interference between a plurality of asynchronous points. Accordingly, the functions of a logic circuit having asynchronous interfaces can be verified more thoroughly and more efficiently.

The designer uses this verification system in the phase of RTL logic simulation, before proceeding to logic synthesis. Problems found at this stage can be corrected easily and quickly since the designer has only to go back to the previous stage to modify the RTL design. This is unlike the errors found in a gate-level simulation or later phases, which would take a long time to correct. The proposed system alleviates the workload of circuit designers and reduces the time for product development and production.

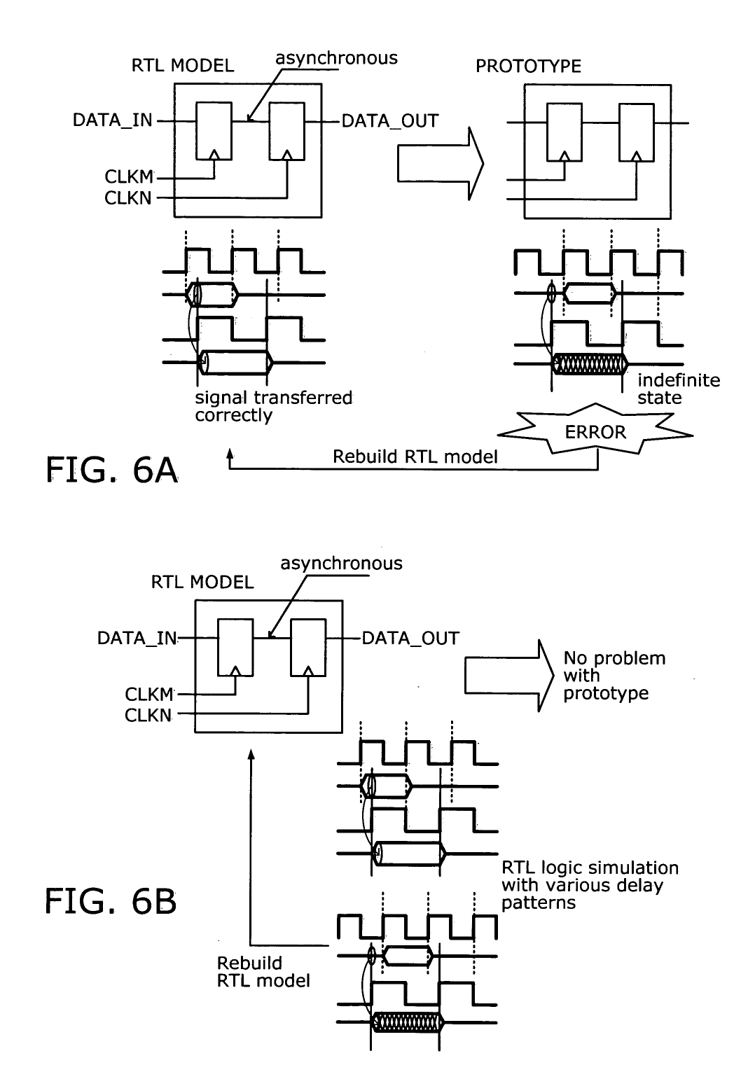

FIGS. 6A and 6B show a benefit of using the proposed functional verification techniques in asynchronous circuit design. Referring to FIG. 6A, conventional design tools sometimes allow an asynchrony-related latent problem to be overlooked in the RTL logic simulation phase. For example, the simulation indicates no problem in transferring a signal from a source circuit operating with a clock signal CLKM to a destination circuit operating with a different clock signal CLKN. This simulation result is not always true to the real chip, meaning that some design defects can remain uncovered until a sample chip is tested in a real-world environment. This necessitates the designer to go back to the RTL design stage to make the necessary corrections, and then follow the same design flow again, including logic simulation and all subsequent steps.

The asynchronous interface verification system 3a of the present invention, however, forcibly introduces additional delays in the phase of RTL logic simulation to create such conditions that could lead to functional errors due to the asynchronous nature of the circuit under test. As FIG. 6B illustrates, this feature of the system permits the designer to find problems in a more accurate and efficient way and make necessary corrections at the RTL level before he/she moves forward to logic synthesis. It almost completely eliminates the chance for a problem to be found in the phase of gate-level logic simulation as a result of, for example, uneven delays of multiple bit lines, as well as the chance for a design flaw to become apparent after the design is implemented in an LSI device. Since the proposed system minimizes the loss of design time in this way, the designer can finish debugging the code in a relatively short period and proceed to sample chip fabrication and evaluation with a higher confidence. Besides lightening the designer's workload effectively, the present invention reduces the development turn-around time of LSI devices and the like.

Referring again to FIG. 5, this circuit design flow, of course, includes several return paths from lower-level design or prototyping phases to RTL design phase, as indicated by the dotted lines. That is, the designer is allowed to go back to step S10 if he/she does not satisfy the result of gate-level logic simulation at step S14, static timing analysis at step S16, or device evaluation at step S18. It is also possible to go back to a middle design phase and iterate the subsequent steps. For example, the designer may want to restart with logic synthesis at step S13, gate-level simulation at step S14, chip layout at step S15, static timing analysis at step S16. This all depends on what kind of problem is found in the evaluation test at step S18.

### Clock Modulation Control

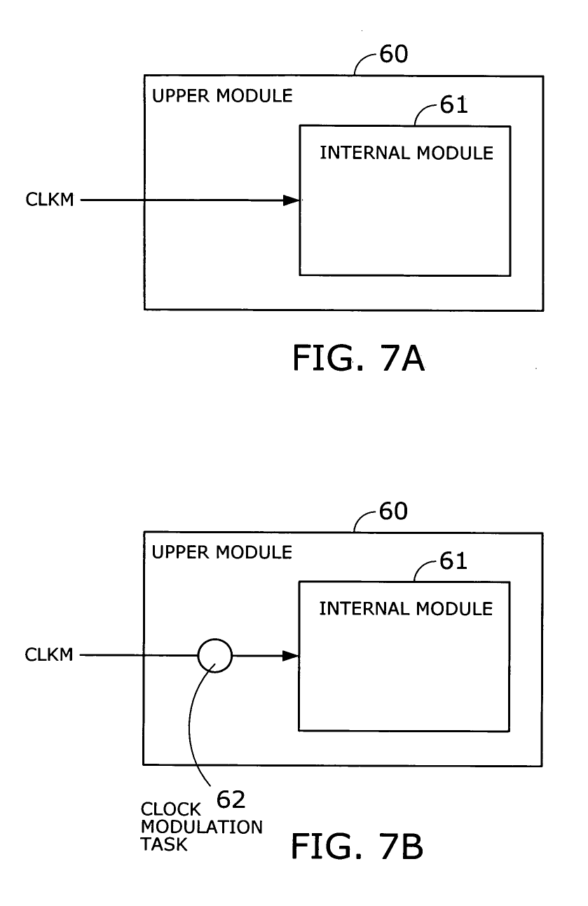

This section provides the details of clock modulation control in the asynchronous interface verification system 3a described above. FIGS. 7A and 7B show a clock modulation task. Referring to FIG. 7A, an RTL code 1 is designed such that a clock CLKM is supplied to an internal module 61 of an upper-level module 60. According to a given control card 21, the control task inserter 20 places a clock modulation task 62 in the RTL code 1 as shown in FIG. 7B. More specifically, this clock modulation task 62 is inserted immediately before the internal module 61 by cutting the clock path of CLKM, thus producing an RTL code 31, or the modified version of the original RTL code 1.

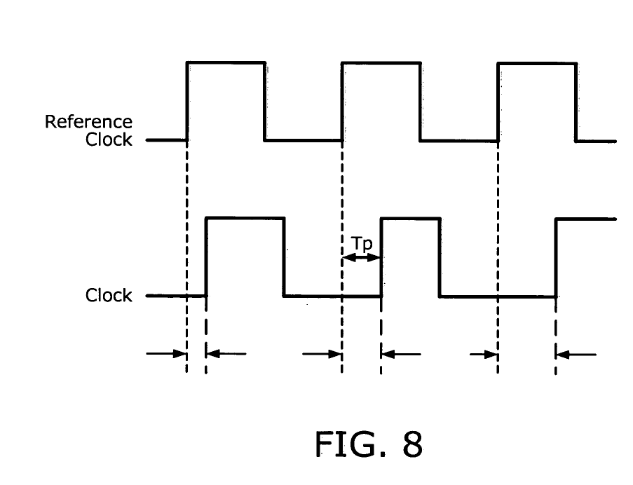

With such a clock modulation task 62 inserted, the simulator 33 can process the RTL code 31 in cooperation with the clock & delay controller 40 to give a certain amount of modulation to the clock signal CLKM. The modulation depth is specified as a combination of three parameters of phase skew, duty, and jitter, which are shown in FIGS. 8, 9, and 10, respectively.

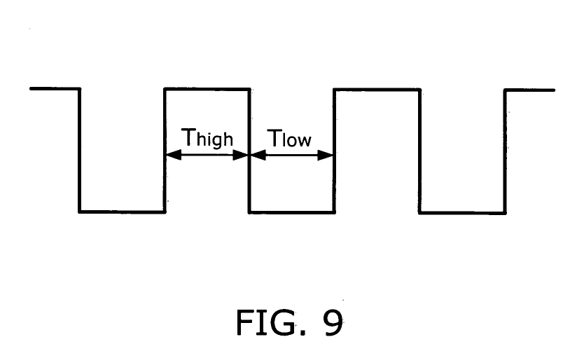

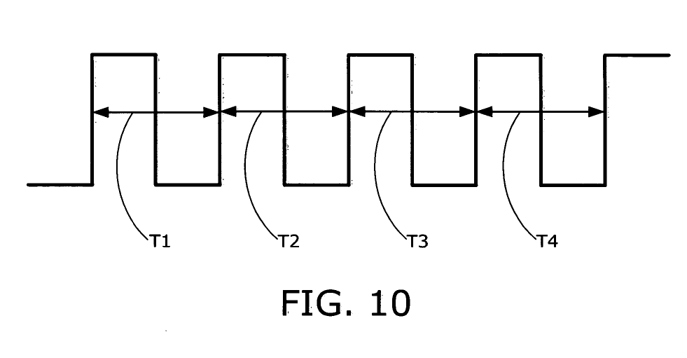

Referring to FIG. 8, the modulated clock has a phase difference Tp with respect to a reference clock. The phase skew parameters give a minimum and maximum phase differences Tp. Referring to FIG. 9, one clock cycle consists of high and low times. The duty parameters give minimum and maximum ratios (T_{low}/T_{high}) of the low time to the high time. Referring to FIG. 10, three clock cycles T1, T2, and T3 are shown. Think of three pairs of consecutive cycles, i.e., (T1,T2), (T2,T3), and (T3,T4). Note that those cycle times are not equal. The jitter parameters give minimum and maximum differences of T2-T1, T3-T2, and T4-T3. Alternatively, when there is a source clock signal with a cycle period of T, the jitter parameters represent minimum and maximum differences of T1-T, T2-T, T3-T, and T4-T.

A modulated clock is produced by modifying a source clock according to the specified phase skew, duty, and jitter parameters. The clock cycle period and duty ratio is automatically calculated such that they will change randomly on an individual cycle basis. A control card 21 provides the details of clock modulation, including: which clocks are selected, and in what range they are modulated. The latter is actually specified by phase skew parameters, duty ratio parameters, and jitter parameters. Those control parameters in the control card 21 are determined automatically by the system on the basis of a given asynchronous point list 12 and, if necessary, changed manually by the designer before he/she performs logic simulation.

To execute a clock modulation task on a clock node specified by given phase skew parameters, the clock & delay controller 40 has a function of determining the length of each clock cycle such that the phase difference of that clock is kept in the range specified by the same phase skew parameters. More specifically, the phase skew range is given as a positive value representing a phase difference of the modulated clock with respect to another clock selected as a reference clock from among those in the circuit. Within the specified phase skew range, the clock & delay controller 40 generates a random phase difference for each cycle period of the clock being modulated. The cycle period of that clock is then determined by shifting its phase as much as the calculated phase difference.

As yet another function for clock modulation, the clock & delay controller 40 determines the clock cycle length such that its jitter will be within a jitter range specified by given jitter parameters. In other words, the clock & delay controller 40 randomizes clock periods, cycle by cycle, so that a jitter is produced within a specified range. While, as discussed earlier, the jitter of a clock signal means the difference in length between two successive cycles, it can also be interpreted as the difference in clock cycle length between before and after modulation.

As still another function for clock modulation, the clock & delay controller 40 determines the high and low times of clock pulses within the duty range specified by duty parameters. This function operates on the clock cycle lengths determined from given phase skew and jitter parameters. That is, the clock & delay controller 40 divides the length of a given clock cycle into high and low times at a particular duty ratio that is within the range specified by a duty ratio parameter.

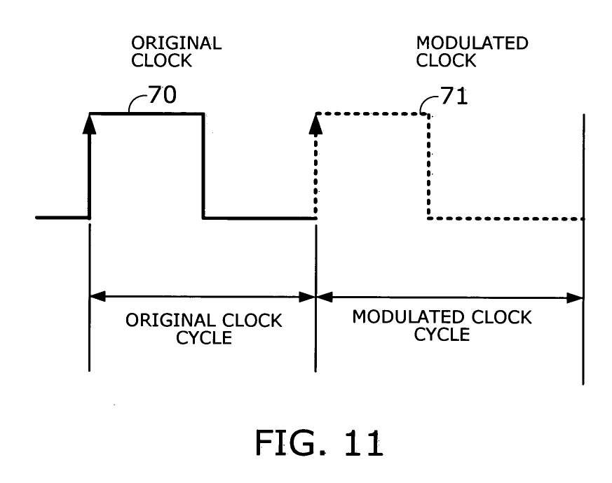

FIG. 11 explains clock modulation. Suppose that the clock & delay controller 40 is to invoke a clock modulation unit based on a control card 21, in order to produce a modified clock cycle 71 from an original clock signal 70. The clock & delay controller 40 first refers to the length of this current clock cycle 70 and applies specified phase skew and jitter parameters to that length, thereby determining the length of the next clock cycle 71. It then determines the high and low times of this clock cycle according to a given range of duty ratios, thus produce a modified clock cycle 71. The clock & delay controller 40 invokes a clock modulation unit, which forcibly inserts the modified clock cycle 71 to the clock modulation task 62 that has been placed in the RTL code 31 under logic simulation as discussed; in FIG. 7. Clock modulation for one cycle period is accomplished in this way. The subsequent clock cycles will be modulated and inserted to the circuit in a similar manner, as the logic simulation proceeds.

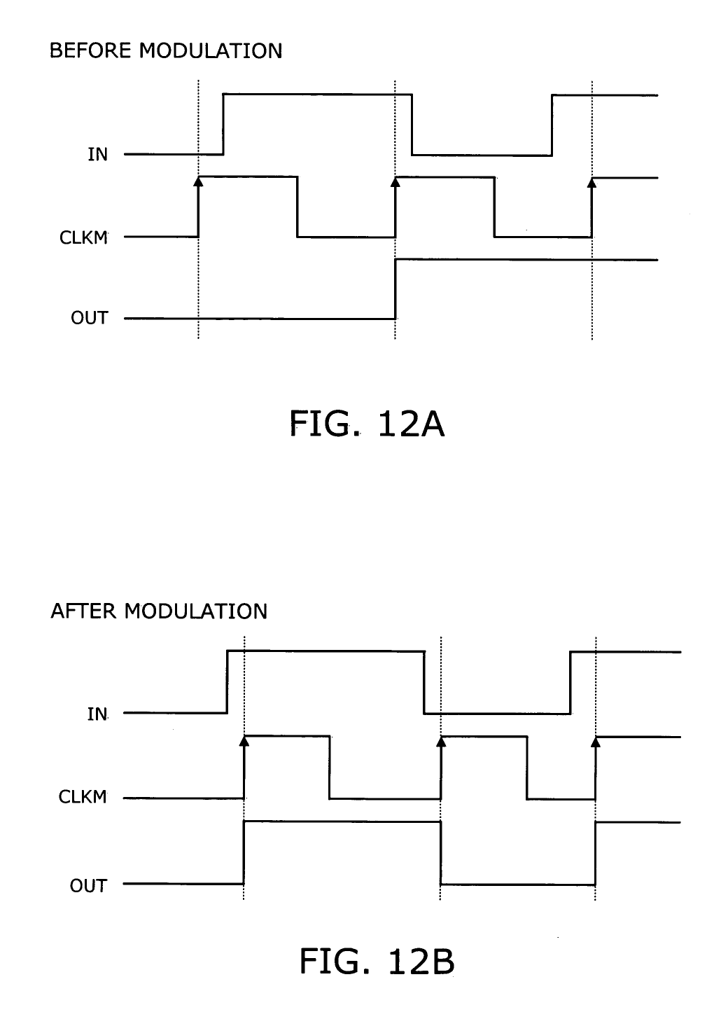

FIGS. 12A and 12B show an example of how a signal is affected by clock modulation. Referring to FIG. 12A, an output signal OUT is produced by sampling an input signal at the rising edge of an unmodulated clock signal CLKM. With clock modulation applied to CLKM, a different output signal OUT appears as illustrated in FIG. 12B. This example demonstrates that the clock modulation can simulate a critical situation in the RTL code 31 where it fails to capture the input signal IN in the way originally intended.

### Signal Delay Control

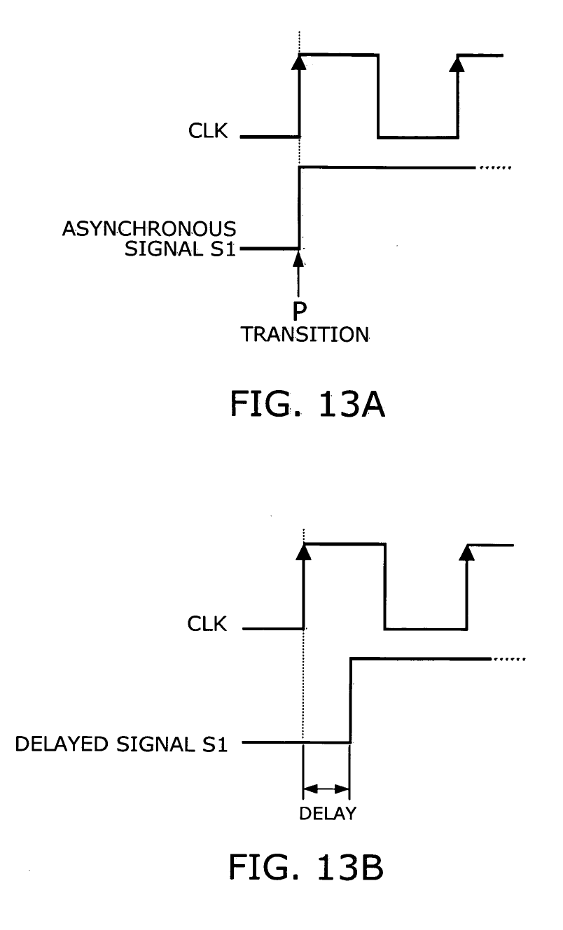

FIGS. 13A and 13B illustrate a signal delay. Referring to FIG. 13A, think of giving a delay to a signal S1 to simulate an unsuccessful signal transfer. This is accomplished by placing and controlling a delay control task to detect a transition P of the signal S1 and, upon detection, to shift the signal S1 by a specified amount of delay as shown in FIG. 13B, so that the circuit cannot capture the high level of the input signal S1 at that time point P.

Such additional signal delays are specified in a control card 21 for asynchronous interface verification. The control card 21 contains control parameters that designate, for example, which signals are to be delayed, in what range the delay should be, and whether the delay insertion should take place at the sending end or the receiving end. Those parameters are automatically produced by the system from an asynchronous point list 12, or manually defined and edited by the user, before the logic simulation can start.

Delay control tasks to be inserted in an RTL code 31 include forcible delay control tasks and delay parameter control tasks, both of which will be described later. The clock & delay controller 40 manipulates those two kinds of delay control tasks to control signal delays. That is, the clock & delay controller 40 is allowed to insert a specified amount of signal delay to each specified point in the logic circuit under test by manipulating delay control tasks.

Based on the control card 21, the clock & delay controller 40 generates a random value for the amount of signal delay, within the range of one cycle period of a clock signal related to the logic circuit of interest, or within a range specified by the user. The amount of delay is calculated once every simulation session, and that value does not change during the session. A new delay value is produced by the clock & delay controller 40 for another simulation session.

The clock & delay controller 40 manages such delay values and clock modulation data (i.e., cycle length and pulse widths) by making records of what random numbers were used to generate them. Specifically, the clock & delay controller 40 is designed to assign a “random number generation ID” to each random number, or each set of random numbers, that it produces. When a particular random number generation ID is specified, the clock & delay controller 40 can reproduce the past simulation session that it conducted with the corresponding delay value.

As one class of delay control tasks, forcible delay control is performed as follows. A delay control unit, when invoked in a logic simulation session, causes the clock & delay controller 40 to record the state of a register input signal before and after its transition. It then waits for an active edge of the clock signal driving that register. When the time comes, the “before state” of the signal stored in the clock & delay controller 40 is forcibly inserted to the register output. Subsequently, after a predetermined amount of delay, the “after state” stored in the clock & delay controller 40 is forcibly inserted to the register output.

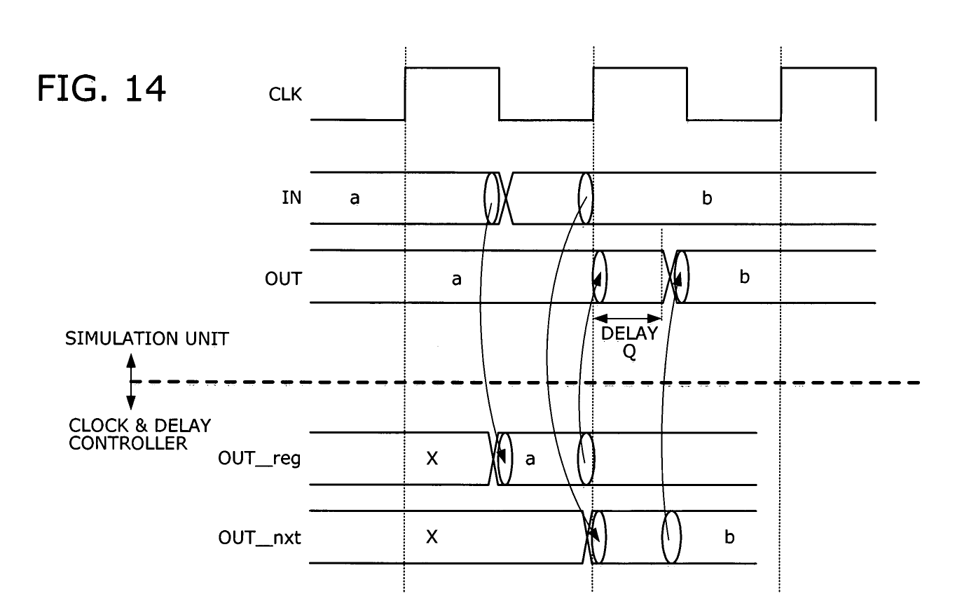

FIG. 14 depicts the forcible delay control outlined above. Think of an RTL code 31 including asynchronous signals that travel across different clock domains. With the assumption that the option of sending-end delay insertion is selected, the control process starts with identifying the source register of this asynchronous signal, as the place where a delay shall be inserted. The source register operates on a clock signal CLK, receiving input data IN and sending output data OUT. The logic simulation tasks include monitoring the input data IN of the source register. In the example of FIG. 14, the state of input data IN changes from “a” to “b” immediately before the clock signal CLK becomes active. This event triggers the clock & delay controller 40 to read and store the before state “a” in a memory OUT_reg. Then, at the active edge of CLK, the clock & delay controller 40 forcibly sets the before state “a” to the output data OUT of the source register, while reading the after state “b” of input data IN and storing it in another memory OUT_nxt. After a predetermined delay time Q, the clock & delay controller 40 forcibly changes the output data OUT from the before state “a” to the after state “b,” thereby accomplishing insertion of a delay time Q to the output data OUT.

Unlike delay parameter control described later, the forcible delay control is only allowed to insert forcible delay control tasks. No essential changes can be imparted to RTL.

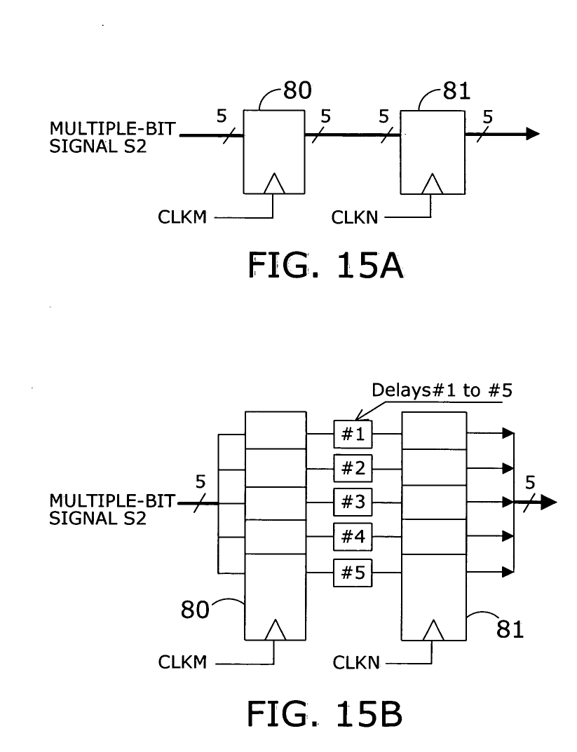

The forcible delay control described in FIG. 14 is applied both to single-bit registers and to multiple-bit registers. FIGS. 15A and 15B show an example of multiple-bit asynchronous: transfer, in; which a five-bit data signal S2 is passed from a sending-circuit 80 in CLKM domain to a receiving circuit 81 in CLKN domain. For simulation with forcible delay insertion, the original circuit of FIG. 15A is modified such that each bit of the signal S2 will have a different delay. Specifically, FIG. 15B shows different delays #1 to #5 given to different bits of S2. This feature of the proposed system permits the designer to verify the circuit behavior through simulation, taking the timing differences between multiple bit signals into consideration.

As another class of delay control tasks, delay parameter control is performed as follows. Upon invocation of a delay control unit by the clock & delay controller 40, delay parameters are inserted to the RTL code 31 for controlling signal delay, so that a predetermined amount of delay is added to a particular circuit in the RTL code 31. Delay parameter control allows a delay to be inserted at either the sending end or the receiving end of an asynchronously transferred signal.

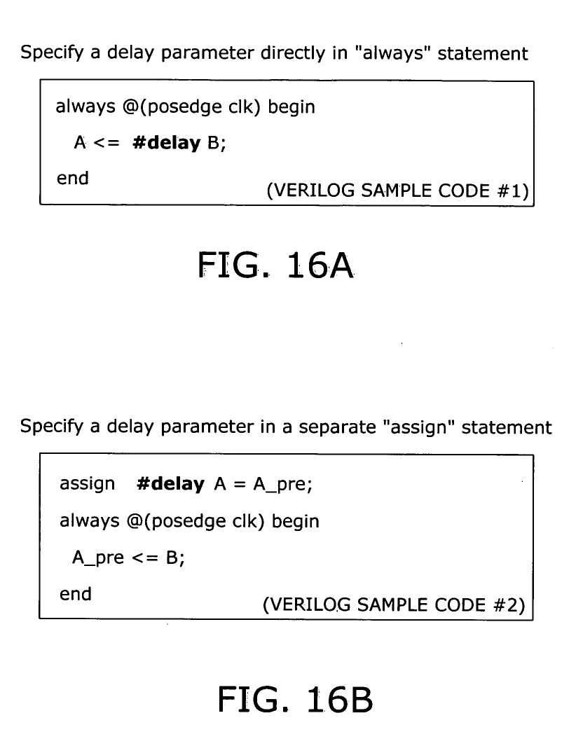

FIGS. 16A and 16B show two examples of delay parameter control for delaying signals at the sending end. The clock & delay controller 40 has a function of inserting delay parameters automatically to the RTL code 31 to add a delay to an output signal of a specified source register. This function, referred to as the “source register delay insertion function,” can be implemented in two ways. One is to specify a delay parameter directly in an “always” statement pertaining to the sending-end circuit, as shown in Verilog sample code #1 of FIG. 16A. Another is to write an “assign” statement specifying a delay parameter, separately from the “always” statement, as shown in Verilog sample code #2 of FIG. 16B.

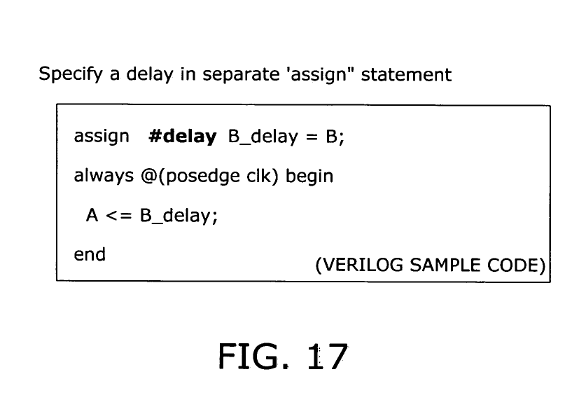

FIG. 17 shows delay parameter control for input signals at the receiving end. In addition to the source register delay insertion described above, the clock & delay controller 40 has a function of giving a delay to a specified input signal, immediately before the receiving register. This function is referred to as the “destination register delay insertion function.” In the RTL code 31, a register is defined as a structured block of statements describing logic operations, including branches and loops. The delay parameter control function automatically inserts necessary delay parameters to an appropriate place in the RTL code 31 such that they will act on the signal after they pass the logic statements defining the register. The Verilog sample code of FIG. 17 shows one way to do this, in which a delay parameter is specified in a separate assign statement at the receiving end.

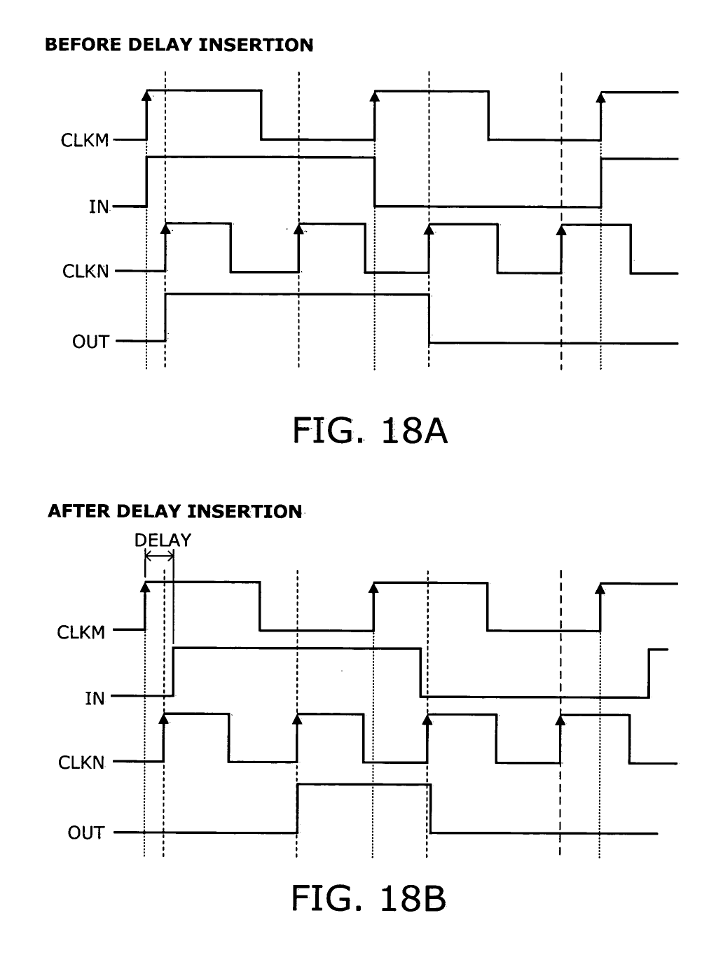

FIGS. 18A and 18B show an example of how a signal changes as a result of delay insertion. Referring to FIG. 18A, the circuit normally receives an input signal IN at the rising edge of CLKM and outputs a signal OUT in synchronization with another clock CLKN. Referring to FIG. 18B, an additional delay to the input signal IN results in, a different waveform of the output signal OUT. Such delay insertion in the process of RTL logic simulation produces an error-prone situation for the signal transferred from CLKM domain to CLKN domain, thus enabling the designer to notice the problem that the signal may be received later than intended.

As can be seen from the above explanation, the proposed asynchronous interface verification system employs an asynchronous point extraction program 11 to extract asynchronous points from a logic circuit given as an RTL code 1. To verify the behavior of an RTL code 31, the asynchronous interface verification system 3a also has a control task inserter 20 to insert control tasks to the RTL code 1, a clock & delay controller 40 to cause those control tasks to generate various delays, and a simulation unit 30 to perform logic simulation of an RTL code 31. Those elements are used to simulate various delays that can happen at asynchronous points in the circuit.

In the logic simulation phase prior to logic synthesis, the designer can test his RTL in greater depth by modulating clocks and inserting signal delays to produce non-simultaneous propagation and consequent indefinite signal state, early propagation, and late propagation. According to the present invention, the proposed techniques greatly raise the probability of encountering indefiniteness at asynchronous points, as well as producing a wide range of possible delay, situations for signals. This feature of the present invention improves the accuracy and efficiency of asynchronous interface verification.

The above-described asynchronous interface verification system 3a will also work well with a gate-level logic simulator. The performance of gate-level simulation will be multiplied because of the increased probability of sampling an indefinite state of signals.

### Log Coverage Collection and Waveform Tracing

This section explains other functions of the asynchronous interface verification system 3a. As described in the preceding sections, the asynchronous interface verification system 3a can work with a simulator 33 in a highly organized way to perform logic simulation of an RTL code 31. During the simulation, the system 3a varies automatically the amount of clock modulation and signal delay. It also allows the user to specify the number of times the simulation is repeated, as well as the date and time when the simulation session has to end. In addition, the system 3a collects log and coverage information of the entire simulation.

Log coverage collection is another function of the asynchronous interface verification system 3a. The simulation results include errors detected as a result of clock modulation or signal delay insertion. The asynchronous interface verification system 3a collects such simulation result information. To help the designer ensure the complete coverage of testing, the asynchronous interface verification system 3a compiles simulation result information together with parameters used in modulating each clock, as well as with parameters used in giving a delay to each asynchronous signal.

The asynchronous interface verification system 3a further compiles simulation result information together with random number generation IDs, so that the designer can track down a particular random number generation ID corresponding to an error that is found in the simulation. The designer can reproduce the error by entering the associated random number generation ID to the system 3a. The clock & delay controller 40 then reproduces a past simulation session that it once performed with the corresponding random value.

Moreover, the asynchronous interface verification system 3a provides statistics about the relationships between simulation results and signal delays added to the RTL code. This function includes compilation of a statistical data table that shows which signal causes errors and how much delay would trigger those errors.

Signal waveform tracing is yet another service that the asynchronous interface verification system 3a offers. When requested by the user, the asynchronous interface verification system 3a can generate a waveform file that shows how the signals change when an additional delay is inserted to an asynchronous point in a given RTL code 31. The user can specify a particular asynchronous point for waveform tracing. The traceable signals include: sending register signals, receiving register signals, sender's clock, and receiver's clock. Waveform files come in the value change dump (VCD) format, for example.

The asynchronous interface verification system 3a visualizes signal changes occurring at a specified asynchronous point. This feature gives the designer a better idea about what error occurs in what surrounding conditions. By using the waveform tracing function to analyze problems found in logic simulation of the RTL code 31, the designer can recreate a source RTL code 1 in a more efficient and appropriate manner.

### Computer Platform

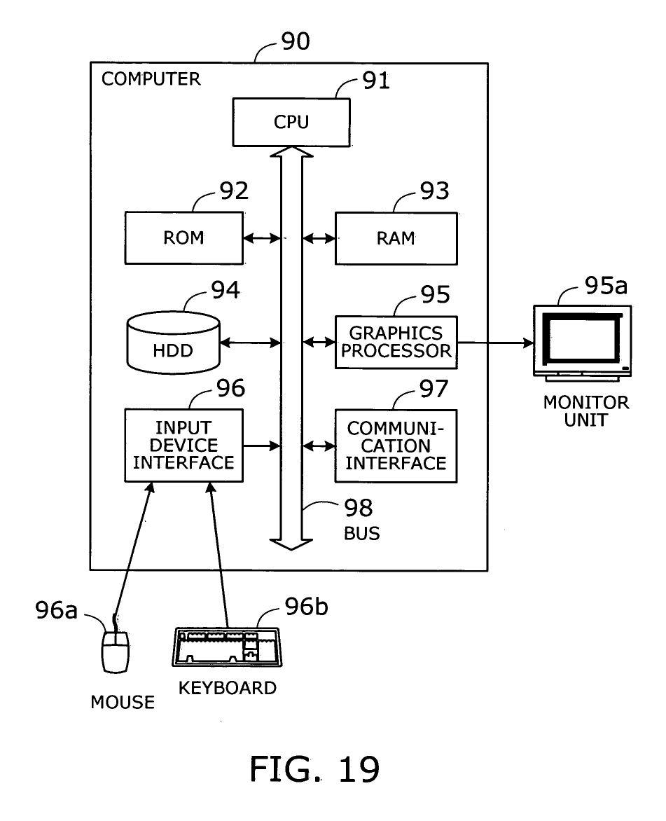

The above-described processing functions of an asynchronous interface verification system are implemented on a computer platform with a hardware structure illustrated in FIG. 19. In this example, the computer 90 comprises a central processing unit (CPU) 91, a read-only memory (ROM) 92, a random access memory (RAM) 93, a hard disk drive (HDD) 94, a graphics processor 95, an input device interface 96, and a communication interface 97. All those components are connected through a bus 98.

The CPU 91 executes instructions according to software programs and data stored in the ROM 92, RAM 93, and HDD 94. The ROM, 92 stores basic programs and data that the CPU 91 executes and manipulates. The RAM 93 serves as temporary storage for application programs and scratchpad data that the CPU 91 executes and manipulates at runtime. The HDD 94 stores program and data files of the operating: system and various applications.

The graphics processor 95 produces video images in accordance with drawing commands from the CPU 91 and displays them on the screen of an external monitor unit 95a coupled thereto. The screen output includes user interface, log and coverage information collected after logic simulation, and signal waveforms. The input device interface 96 receives input signals from a keyboard 96b and a mouse 96a and supplies them to the CPU 91 via the bus 98. The communication interface 97 is connected to a local area network or the Internet, allowing the CPU 91 to exchange data with other computers (not shown).

The asynchronous interface verification system is built on one or more computers with the structure shown in FIG. 19, the processing functions being encoded and provided in the form of computer programs. The computer system executes such programs to provide the intended functions of the present invention. Such programs are stored in a computer-readable storage medium. The suitable computer-readable storage media include magnetic storage media, optical discs, magneto-optical storage media, and solid state memory devices. Magnetic storage media include hard disk drives (HDD), flexible disks (FD), and magnetic tapes. Optical discs include digital versatile discs (DVD), DVD-RAM, compact disc read-only memory (CD-ROM), CD-Recordable (CD-R), and CD-Rewritable (CD-RW). Magneto-optical storage media include magneto-optical discs (MO).

Portable storage media, such as DVD and CD-ROM, are suitable for distribution of program products. Network-based distribution of software programs is also possible, in which master program files are made available in a server computer for downloading to user computers via a network. Each user computer stores the required programs in its local storage unit, which have previously been installed from a portable storage media or downloaded from a server computer. The user computer performs intended functions by executing programs read out of the local storage unit. As an alternative way of program execution, the computer may execute programs directly from a portable storage medium while reading out necessary program files. Another alternative method is that the user computer dynamically downloads programs from a server computer when they are demanded and executes them upon delivery.

### System Applications

This section presents an application of the asynchronous interface verification system according to the present embodiment. For an example of an asynchronous interface simulation, let us consider an RTL circuit designed to resynchronize signals for transport from one clock domain (S_CLK) to another clock domain (A_CLK), or vice versa. This circuit, named “TBridge_top,” employs a double synchronizer, or two cascaded stages of flip-flops, for receiving each asynchronous signal. The two clock systems S_CLK and A_CLK form clock groups in this case. S_CLK is not synchronized with A_CLK, meaning that they are out of phase with each other. Their frequencies are not specified, while their relationship may be either of the following:
Fast: S_CLK>A_CLK
Typ: S_CLK=A_CLK
Late: S_CLK<A_CLK
   Reset operation is supposed to be initiated from S_CLK domain, and it will always take effect, no matter whether the other clock A_CLK is stopped or not. The data transferred from S_CLK domain to A_CLK domain has a width of 32 bits.

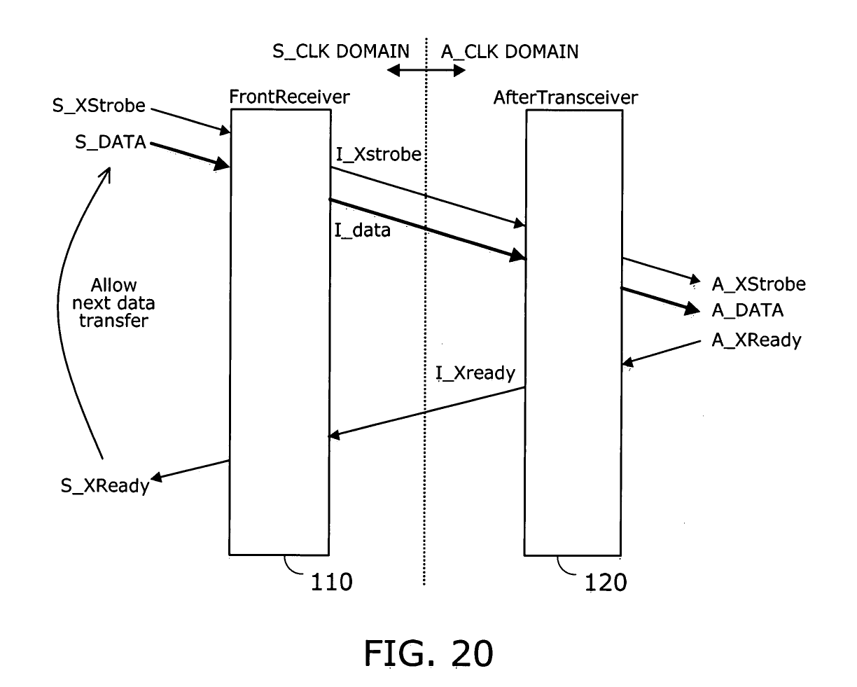

FIG. 20 shows signal propagation in the TBridge_top circuit. The circuit is composed of a front-end receiver (FrontReceiver) 110 operating on S_CLK and a subsequent transceiver circuit (AfterTransceiver) 120 operating on A_CLK. Data and timing signals are sent from the FrontReceiver 110 to the AfterTransceiver 120, and an acknowledge signal is returned in the opposite direction.

More specifically, the FrontReceiver 110 reads input data S_DATA upon receipt of a timing signal S_Xstrobe. This data is passed from the FrontReceiver 110 to the AfterTransceiver 120 as intermediate data I_data with a timing signal I_Xstrobe. The AfterTransceiver 120 then outputs a timing signal A_Xstrobe and output data A_DATA, accordingly. After that, AfterTransceiver 120 receives an acknowledgment signal A_Xready indicating the end of the data transfer operation, which is passed to the FrontReceiver 110 as an intermediate signal I_Xready. This I_Xready signal finally turns into S_Xready sent out of the FrontReceiver 110, which permits the FrontReceiver 110 to start another cycle of data transfer.

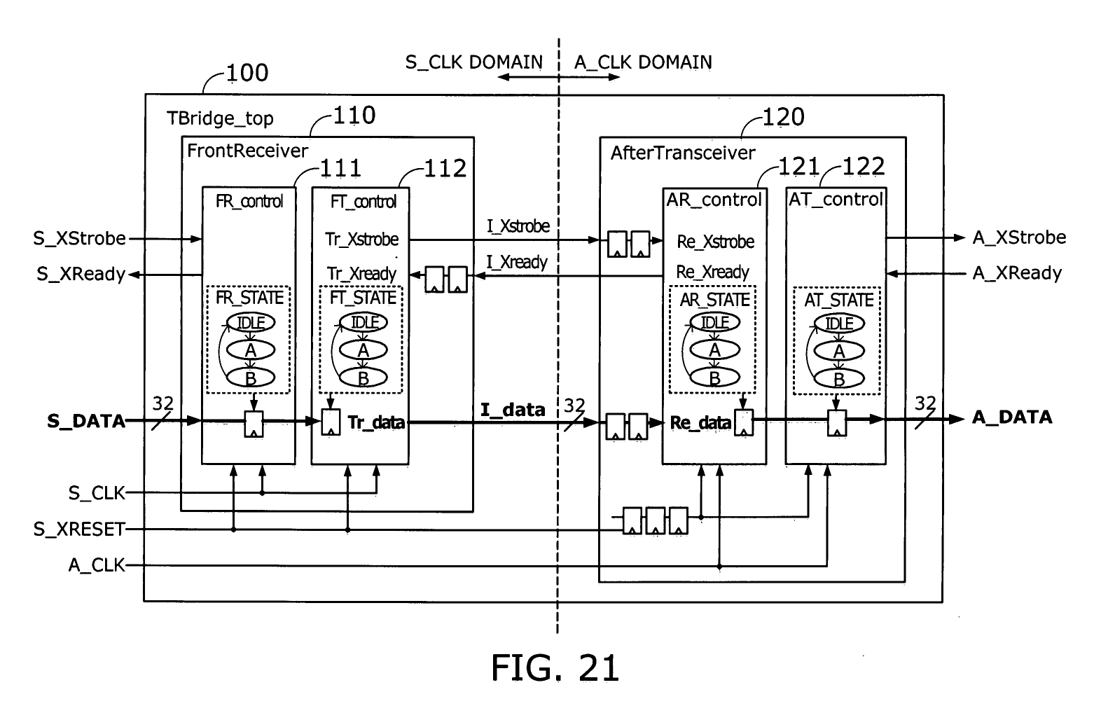

FIG. 21 is a block diagram of the TBridge_top circuit 100. As already mentioned, the TBridge_top circuit 100 is composed of two sections: FrontReceiver 110 in S_CLK domain and AfterTransceiver 120 in A_CLK domain. The FrontReceiver 110 has a reception controller (FR_control) 111 and a transmission controller (FT_control) 112. Their respective states FR_STATE and FT_STATE change in response to input signals, and their output signals are controlled accordingly. Similarly, the AfterTransceiver 120 has a reception controller (AR_control) 121 and a transmission controller (AT_control) 122. Their respective states AR_STATE and AT_STATE change in response to input signals, and their output signals are controlled accordingly.

The FR_control 111 receives S_DATA qualified by S_Xstrobe, which causes the FT_control 112 to produce Tr_data. This Tr_data, together with a timing signal Tr_Xstrobe, is sent out as I_data, which is then entered to the AR_control 121 as Re_data. The reception of Re_data triggers the AR_control 121 to produce Re_Xstrobe and Re_Xready.

The received Re_data is supplied from the AR_control 121 to the AT_control 122 for delivery as A_DATA, along with A_Xstrobe. When A_Xready is entered to the AT_control 122, the AR_control 121 sends out its internal Re_Xready as I_Xready, which reaches the FT_control 112 as Tr_Xready. With this Tr_Xready, the FR_control 111 sends out S_Xready, allowing the FrontReceiver 110 to start another data transfer cycle.

As mentioned earlier, the reset signal S_XRESET is provided from the S_CLK domain S_XRESET takes effect even if the other clock A_CLK is stopped.

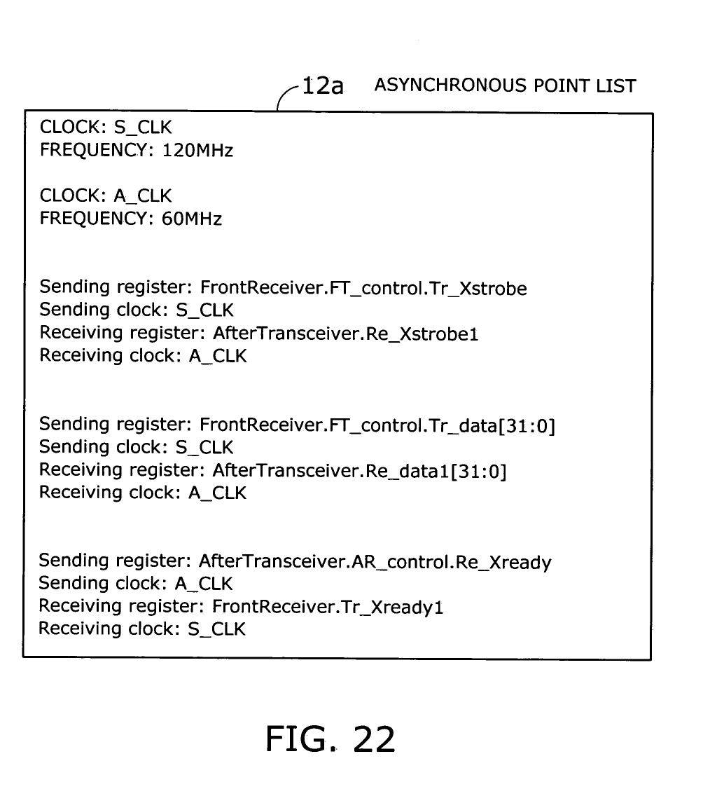

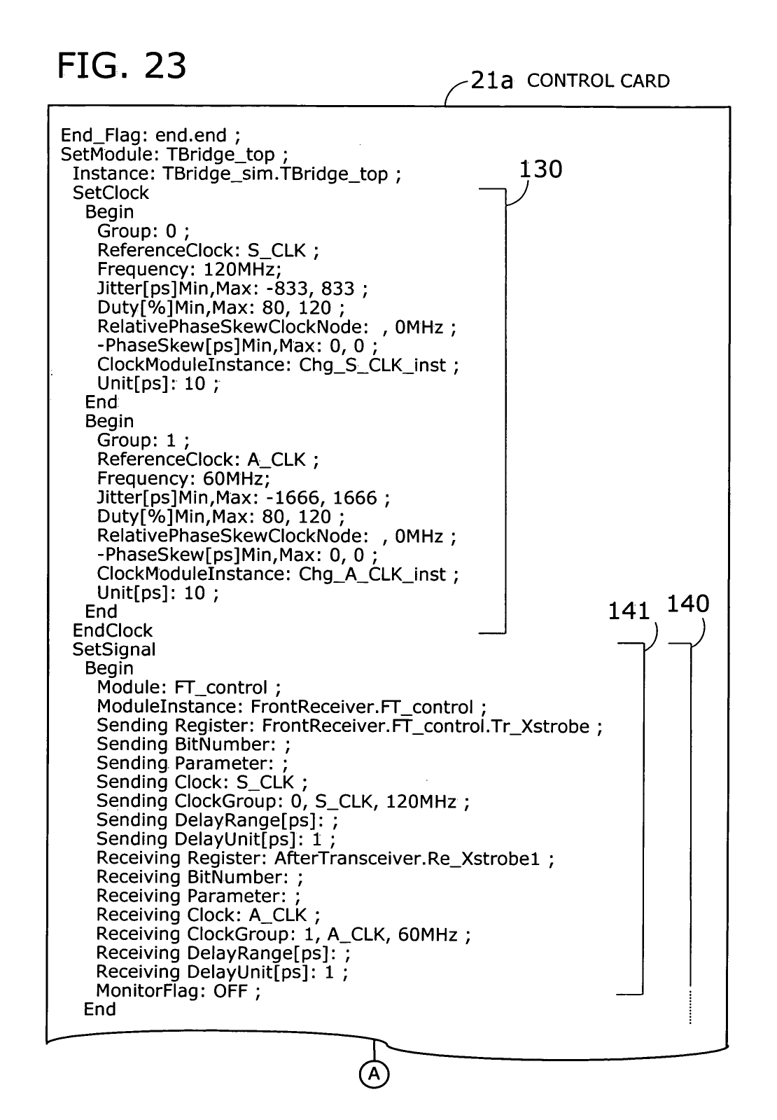

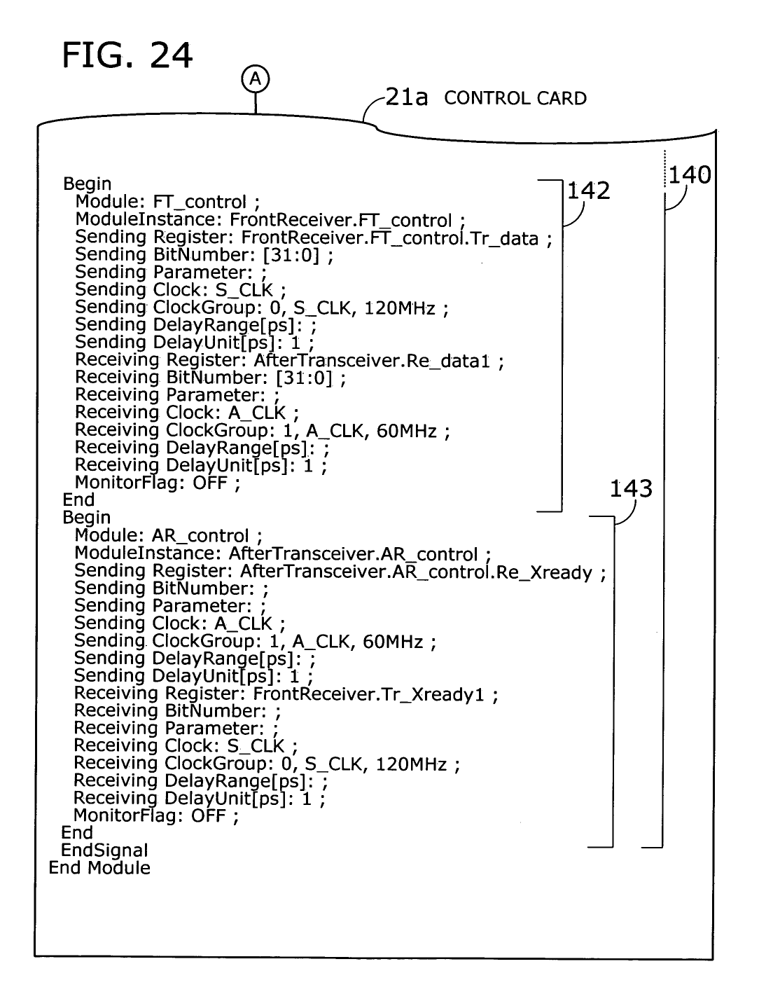

FIG. 22 shows the asynchronous point list of TBridge_top, and FIGS. 23 and 24 show a control card corresponding to that list. Referring to FIG. 22, the asynchronous point list 12a first describes two clock groups: a 120 MHz clock group S_CLK and a 60 MHz clock group A_CLK. It also describes three asynchronous signals in the TBridge_top circuit 100, which are:
Tr_Xstrobe (S_CLK) and Re Xstorobe (A_CLK)
Tr_data[31:0] (S_CLK) and Re_data[31:0] (A_CLK)
Re_Xready (A_CLK) and Tr_Xready (S_CLK)

This asynchronous point list. 12a derives a control card 21a shown in FIGS. 23 and 24.

Referring to FIGS. 23 and 24, the control card 21a contains various control parameters for logic simulation, which are defined in two separate sections: SetClock and SetSignal. The SetClock section 130 has jitter parameters, duty parameters, and phase skew parameters for both S_CLK (Group:0) and A_CLK (Group:1). Also included is a unit delay parameter that defines the step size of delay, 10 ps in this example.

The SetSignal section 140 is composed of several sub-sections 141, 142, and 143 corresponding to individual asynchronous signals. Each SetSignal sub-section describes sending and receiving circuits, the number of unit delays in logic simulation, and other related information. Take the topmost SetSignal sub-section 141, for example. According to this sub-section, the FT_control 112 in the. FrontReceiver 110 sends Tr_Xstrobe, and the AfterTransceiver 120 receives it as Re_Xstrobe, where the sending: end operates on a 120-MHz clock signal S_CLK, while the receiving end operates on a 60-MHz clock signal A_CLK.

Similarly, the next SetSignal sub-section 142 shown in FIG. 24 describes the following: The FT_control 112 in the FrontReceiver 110 sends Tr_data[31:0], and the AfterTransceiver 120 receives it as Re_data, where the sending end operates on a 120-MHz clock signal S_CLK, while the receiving end operates on a 60-MHz clock signal A_CLK. Further, according to the last SetSignal sub-section 143, the AR_control 121 in the AfterTransceiver 120 sends Re_Xready, and the FrontReceiver 110 receives it as Tr_Xready, where the sending end operates on a 60-MHz clock signal A_CLK, while the receiving end operates on a, 120-MHz clock signal S_CLK.

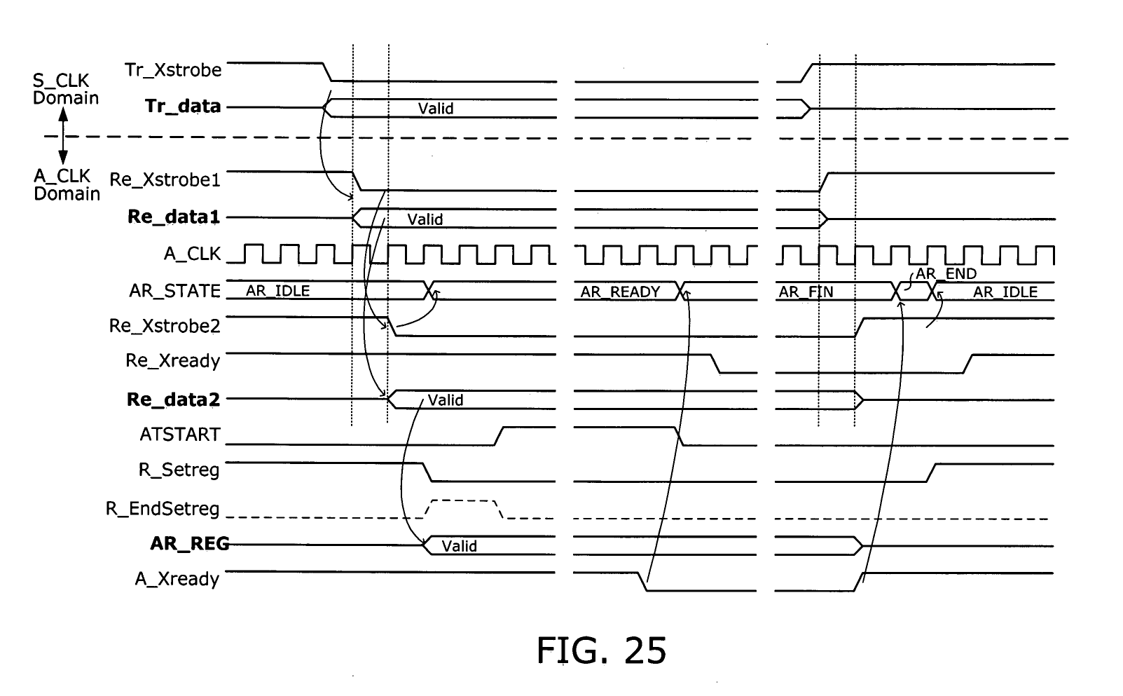

FIG. 25 is a timing diagram showing the originally intended behavior of the TBridge_top circuit 100. Logic simulation is performed to ensure that the TBridge_top circuit 100 operates exactly in the way shown in FIG. 25. A test bench is prepared to generate alternate S_DATA values of 32′haaaa_aaaa and 32′h5555_{—}5555, so that the TBridge_top circuit 100 will receive 0s and is in a checker pattern. For each simulated data transfer cycle, it is determined whether the resulting A_DATA agrees with each given S_DATA when A_Xstrobe is active. If the two values agrees, it means “pass”; i.e., the data has been transferred correctly. If not, it means “fail” and the simulator produces an error message that puts the erroneous A DATA in contrast with its expected value. The logic simulator tests the TBridge_top circuit 100 by repeating such test patterns 500 times.

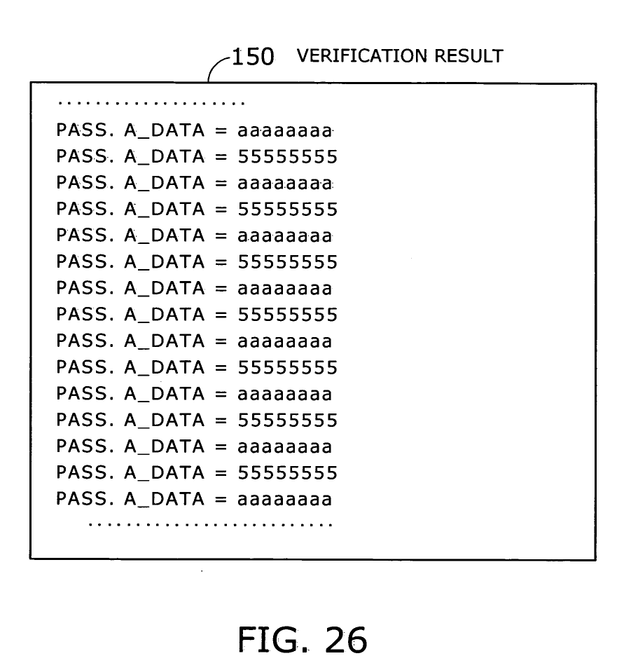

FIG. 26 shows a list of A_DATA values, which is a part of the results obtained from a conventional RTL logic simulation. As seen from this verification result 150, the conventional RTL logic simulation detects no errors, thus suggesting that, the TBridge_top circuit 100 transfers asynchronous signals correctly between S_CLK and A_CLK domains. Further, the simulation yields the same result, no matter which condition (“Fast,” “Typ,” “Late”) is set.

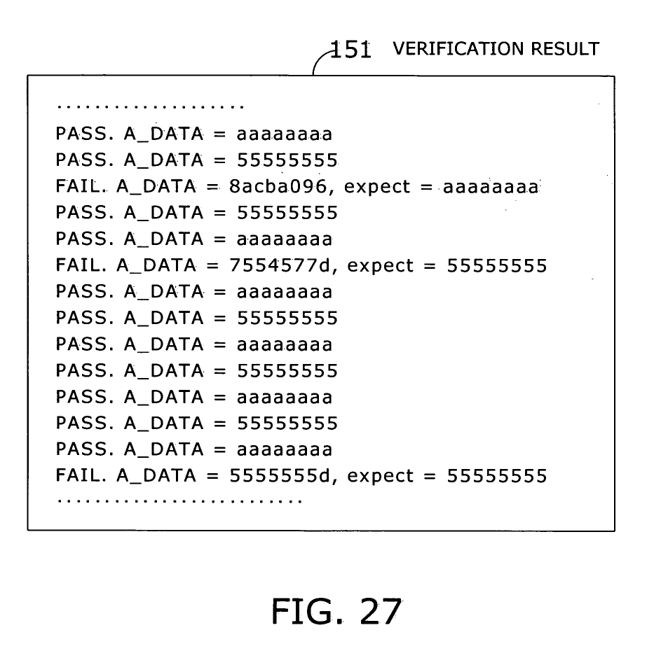

FIG. 27 shows the result from the same RTL, and same test bench, but with the asynchronous interface verification system of the present invention. This verification result 151 is quite different from that of FIG. 26. Specifically, the list includes three lines of “fail,” which supposedly derive from a non-simultaneous signal change that has occurred in the S_CLK domain and propagated to the A_CLK domain. If this is really the case, the TBridge_top circuit 100 must have a latent problem in its functionality.

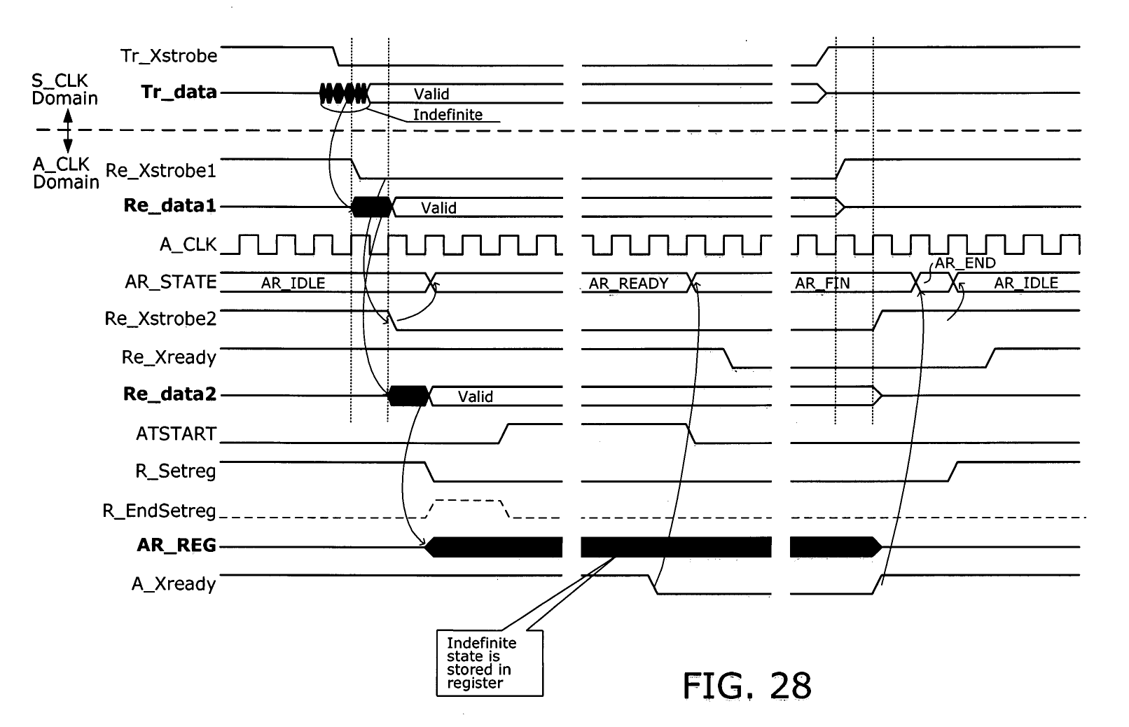

The above behavior of the TBridge_top circuit 100 can be depicted in the form of a timing diagram. Referring to FIG. 28, an indefinite state occurs to Tr_data in the S_CLK domain, which renders Re_data1 indefinite in the A_CLK domain. The indefiniteness of Re_data1 propagates to Re_data2 at the next clock edge, and this Re_data2 is entered to a register AR_REG in the AR_control 121.

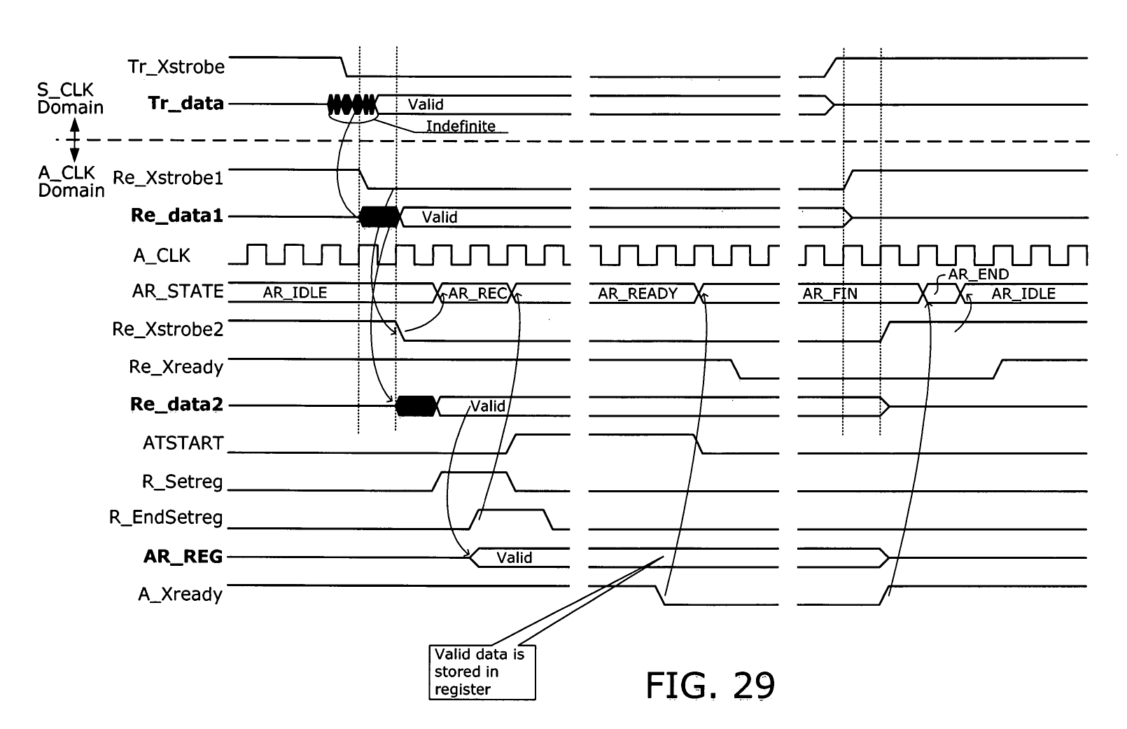

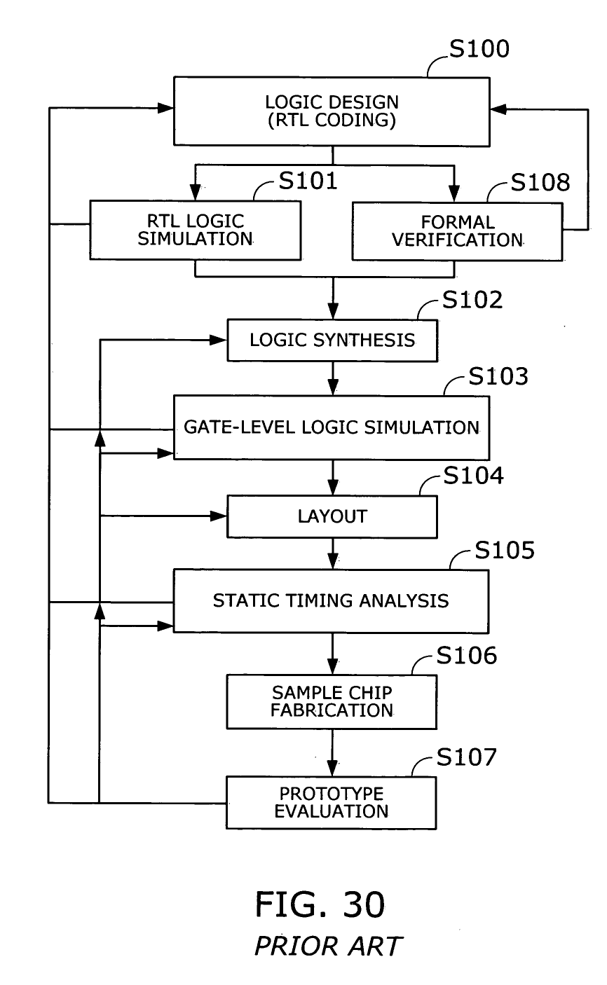

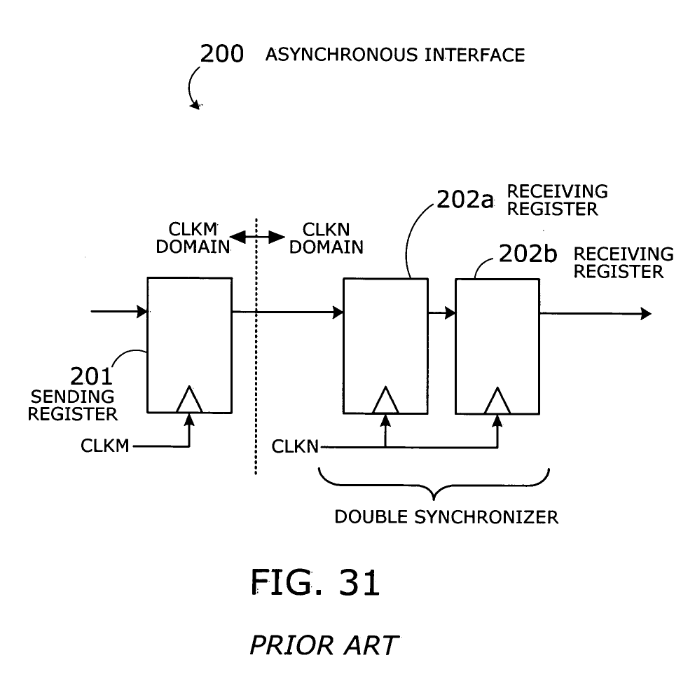

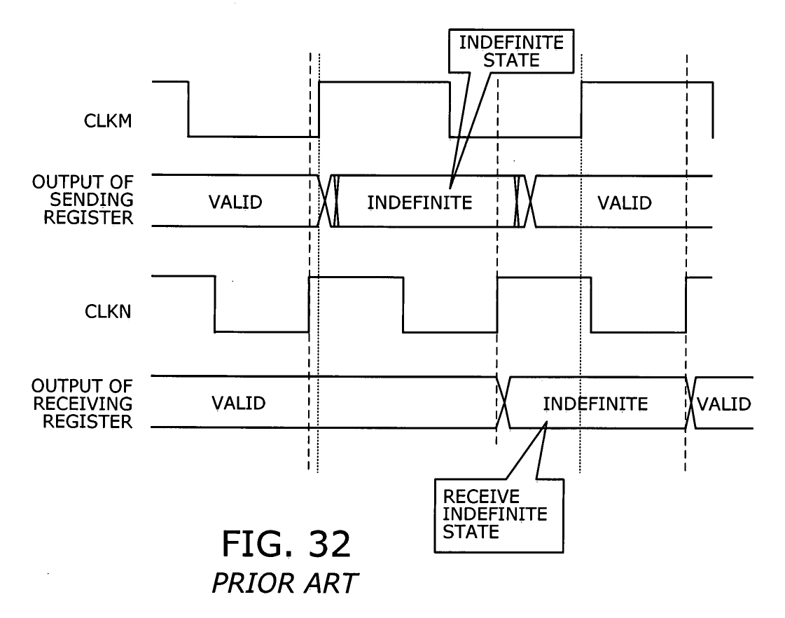

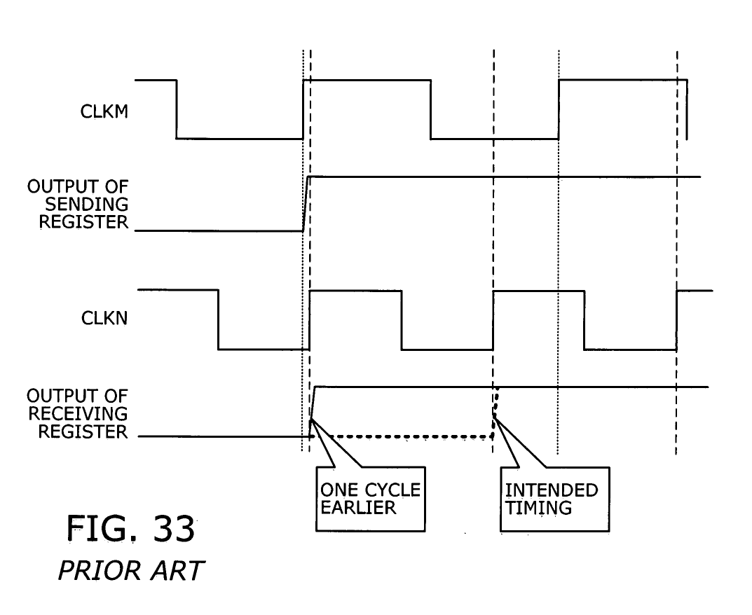

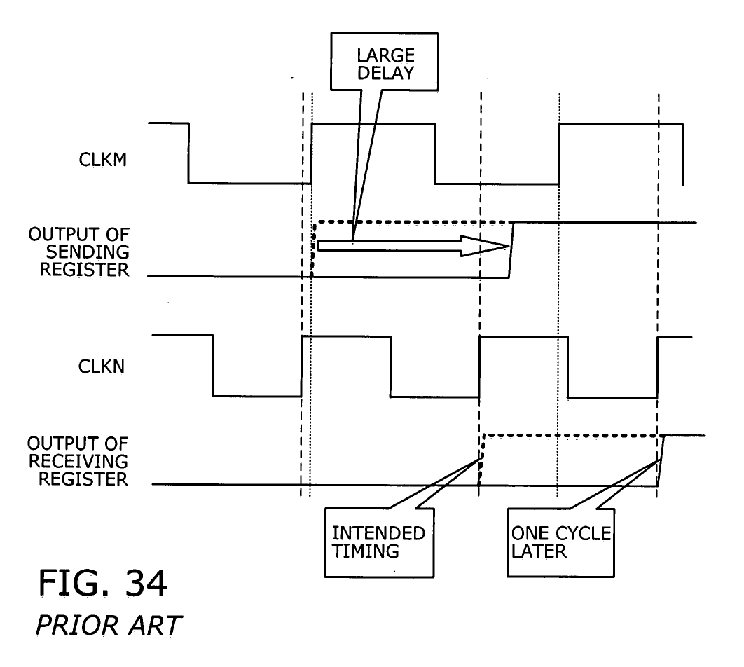

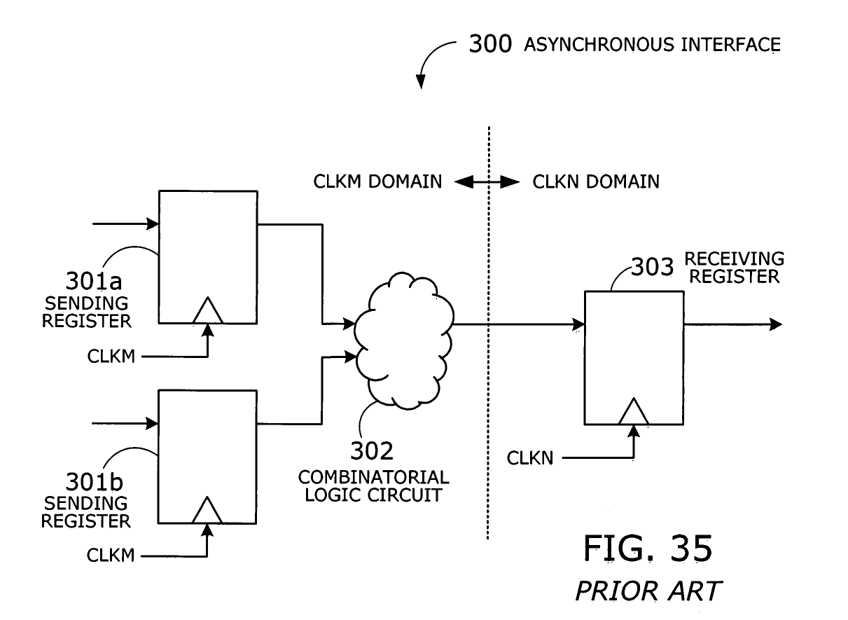

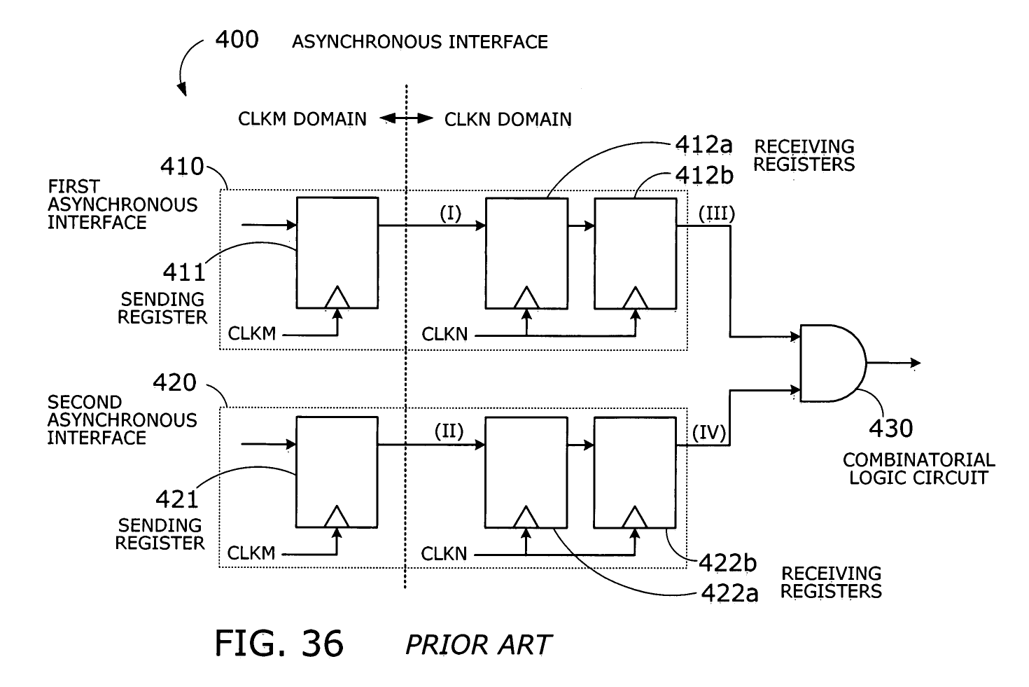

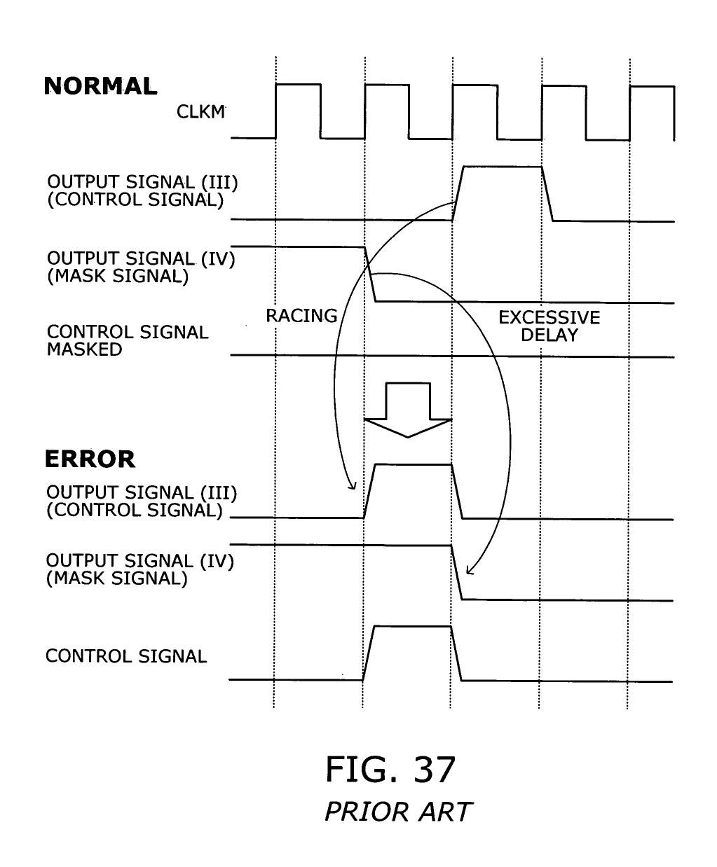

The TBridge_top circuit 100 may be modified to avoid the situation of FIG. 28. FIG. 29 is a timing diagram showing the operation of a modified version of the TBridge_top circuit 100. According to this new timing diagram, R_Setreg (set register signal) in the A_CLK domain is redesigned, and another signal R_EndSetreg is added. This change prevents AR_REG from capturing an indefinite: state of Re_data2, thus ensuring validity of the content of AR_REG.

By incorporating the proposed asynchronous interface verification system into RTL simulation phase, the designer can test whether the TBridge_top circuit 100 can transfer signals correctly at its asynchronous points, before proceeding to logic synthesis. The present invention provides an improved design workflow, not only in the functional verification stage, but also in the subsequent steps.

### Conclusion

To summarize the above explanation, the proposed asynchronous interface verification system extracts asynchronous points from a logic circuit under test and verifies correct signal transfer across those points in the RTL simulation phase, prior to logic synthesis. This verification process includes modulating a clock signal and inserting a signal delay at each asynchronous point to simulate such situations as non-simultaneous propagation, early propagation, and late propagation. Besides testing the circuit's behavior at the exact asynchronous points, the proposed verification system examines subsequent signal propagation on other circuits and possible interference between asynchronous points. Accordingly, the functions of a logic circuit having asynchronous interfaces can be verified in a more accurate and efficient way. Thus the proposed system alleviates the workload of circuit designers and greatly reduces the time for development and production.

According to the present invention, the circuit design process includes clock modulation and signal delay generation in the phase of RTL logic simulation to produce various situations that may actually be encountered at asynchronous points. The simulator permits the circuit to experience frequent non-simultaneous propagation, early propagation, late propagation, and other situations peculiar to asynchronous interfaces. Besides testing operation at the exact asynchronous points that are extracted, the proposed verification system examines subsequent signal propagation on other circuits and possible interference between a plurality of asynchronous points. Accordingly, the functions of a logic circuit having asynchronous interfaces can be verified in a more accurate and efficient way.

The designer uses this verification system in the phase of RTL logic simulation, before proceeding to logic synthesis. Problems found at this stage can be corrected easily and quickly since the designer has only to go back to the previous stage to modify the logic design. This is unlike the errors found in a gate-level simulation or later phases, which would take a long time to correct. The proposed system alleviates the workload of circuit designers and reduces the time for development and production.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A method of verifying behavior of a logic circuit having an asynchronous interface, comprising the steps of:
extracting an asynchronous point from a logic circuit defined at a register transfer level; and
verifying functionality of the logic circuit through simulation, taking into account a delay that could occur at the extracted asynchronous point.

2. The method according to claim 1, wherein the delay is: produced by modulating a clock signal in the logic circuit according to given parameters.

3. The method according to claim 1, wherein the delay is produced by inserting a signal delay to the logic circuit according to given parameters.

4. The method according to claim 2, wherein said modulating of the clock signal comprises the substeps of:
inserting a clock modulation task to a specified clock path in the logic circuit; and
giving a modulated clock to the clock modulating task inserted.

5. The method according to claim 2, wherein the modulation is applied to each cycle of the clock signal to be modulated.

6. The method according to claim 3, wherein said inserting of the signal delay comprises the substeps of:
inserting a delay control task to the logic circuit; and
giving the signal delay to the delay control task inserted.

7. The method according to claim 3, further comprising the steps of:
recording a delay value used at each simulation session; and
executing again a past simulation session with a particular delay value when said particular delay value is specified.

8. A program product stored in a computer-readable storage medium for verifying behavior of a logic circuit having an asynchronous interface, the program product causing a computer system to function as an apparatus comprising:
an asynchronous point extractor that extracts an asynchronous point in a logic circuit defined at a register transfer level; and
a verifier that verifies functionality of the logic circuit through simulation, taking into account a delay that could occur at the asynchronous point extracted by said asynchronous point extractor.

9. The program product according to claim 8, wherein said verifier produces the delay by modulating a clock signal in the logic circuit according to given parameters.

10. The program product according to claim 8, wherein said verifier produces the delay by inserting a signal delay to the logic circuit according to given parameters.

11. The program product according to claim 9, wherein said verifier inserts a clock modulation task to a specified clock path in the logic circuit and gives a modulated clock to the clock modulating task inserted.

12. The program product according to claim 9, wherein said verifier applies the modulation to each cycle of the clock signal to be modulated.

13. The program product according to claim 10, wherein said verifier inserts a delay control task to the logic circuit and gives the signal delay to the delay control task inserted.

14. The program product according to claim 10, wherein said verifier records a delay value used at each simulation session and executes again a past simulation session with a particular delay value when said particular delay value is specified.

15. A program product stored in a computer-readable storage medium for verifying behavior of a logic circuit having an asynchronous interface, the program product causing a computer system to function as an apparatus comprising:
a control task inserter that inserts a control task to an asynchronous point in a logic circuit defined at a register transfer level; and
a delay controller that uses the control task to produce a delay in the logic circuit during a simulation thereof.

16. The program product according to claim 15, wherein said delay controller produces the delay by giving a modulated clock to the control task in the logic circuit according to given parameters.

17. The program product according to claim 15, wherein said delay controller produces the delay by giving a signal delay to the control task in the logic circuit according to given parameters.

18. A system for verifying behavior of a logic circuit having an asynchronous interface, comprising:
an asynchronous point extractor that extracts an asynchronous point in a logic circuit defined at a register transfer level; and
a verifier that verifies functionality of the logic circuit through simulation, taking into account a delay that could occur at the asynchronous point extracted by said asynchronous point extractor.

19. The system according to claim 18, wherein said verifier produces the delay by modulating a clock signal in the logic circuit according to given parameters.

20. The system according to claim 18, wherein said verifier produces the delay by inserting a signal delay to the logic circuit according to given parameters.

21. The system according to claim 19, wherein said verifier inserts a clock modulation task to a specified clock path in the logic circuit and gives a modulated clock to the clock modulating task inserted.

22. The system according to claim 19, wherein said verifier applies the modulation to each cycle of the clock signal to be modulated.

23. The system according to claim 20, wherein said verifier inserts a delay control task to the logic circuit and gives the signal delay to the delay control task inserted.

24. The system according, to claim 20, wherein said verifier records a delay value used at each simulation session and executes again a past simulation session with a particular delay value when said particular delay value is specified.

25. A system for verifying behavior of a logic circuit having an asynchronous interface, comprising:
a control task inserter that inserts a control task to an asynchronous point in a logic circuit defined at a register transfer level; and
a delay controller that uses the control task to produce a delay in the logic circuit during a simulation thereof.

26. The system according to claim 25, wherein said delay controller produces the delay by giving a modulated clock to the control task in the logic circuit according to given parameters.

27. The system according to claim 25, wherein said verifier produces the delay by giving a signal delay to the control task in the logic circuit according to given parameters.
